(19) United States
(12) Patent Application Publication
(10) Pub. No.: US 2020/0341904 A1
(43) Pub. Date: Oct. 29, 2020

(54) TECHNOLOGIES FOR CHAINED MEMORY SEARCH WITH HARDWARE ACCELERATION

(71) Applicant: Intel Corporation, Santa Clara, CA (US)

(72) Inventors: Anjaneya Reddy Chagam Reddy, Chandler, AZ (US); Scott D. Peterson, Beaverton, OR (US); Narayan Ranganathan, Bangalore (IN)

(21) Appl. No.: 16/395,891

(22) Filed: Apr. 26, 2019

(51) Int. Cl. G06F 12/10

(52) U.S. Cl. CPC G06F 12/10

(57) ABSTRACT

Technologies for accelerated memory lookups include a computing device having a processor and a hardware accelerator. The processor programs the accelerator with a search value, a start pointer, one or more predetermined offsets, and a record length. Each offset may be associated with a pointer type or a value type. The accelerator initializes a memory location at the start pointer and increments the memory location by the offset. The accelerator may read a pointer value from an offset, set the memory location to the pointer value, and repeat for additional offsets. The accelerator may read a value from the offset and compare the value to the search value. If the values match, the accelerator returns the address of the matching value to the processor. If the values do not match, the accelerator searches a next record based on the record length. Other embodiments are described and claimed.

### BACKGROUND

A compute device may include multiple processor cores or other compute engines. Current compute devices may include multiple volatile and non-volatile memory devices that collectively may store terabytes of data. Searching large amounts of memory for a particular value or values using the compute engines is a compute-cycle intensive operation and may cause cache pollution.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified diagram of at least one embodiment of a data center for executing workloads with disaggregated resources;

FIG. 2 is a simplified diagram of at least one embodiment of a pod that may be included in the data center of FIG. 1;

FIG. 3 is a perspective view of at least one embodiment of a rack that may be included in the pod of FIG. 2;

FIG. 4 is a side elevation view of the rack of FIG. 3;

FIG. 5 is a perspective view of the rack of FIG. 3 having a sled mounted therein;

FIG. 6 is a is a simplified block diagram of at least one embodiment of a top side of the sled of FIG. 5;

FIG. 7 is a simplified block diagram of at least one embodiment of a bottom side of the sled of FIG. 6;

FIG. 8 is a simplified block diagram of at least one embodiment of a compute sled usable in the data center of FIG. 1;

FIG. 9 is a top perspective view of at least one embodiment of the compute sled of FIG. 8;

FIG. 10 is a simplified block diagram of at least one embodiment of an accelerator sled usable in the data center of FIG. 1;

FIG. 11 is a top perspective view of at least one embodiment of the accelerator sled of FIG. 10;

FIG. 12 is a simplified block diagram of at least one embodiment of a storage sled usable in the data center of FIG. 1;

FIG. 13 is a top perspective view of at least one embodiment of the storage sled of FIG. 12;

FIG. 14 is a simplified block diagram of at least one embodiment of a memory sled usable in the data center of FIG. 1; and

FIG. 15 is a simplified block diagram of a system that may be established within the data center of FIG. 1 to execute workloads with managed nodes composed of disaggregated resources.

FIG. 16 is a simplified block diagram of at least one embodiment of a system for hardware accelerated memory lookups;

FIG. 17 is a simplified block diagram of at least one embodiment of an environment that may be established by a computing device of FIG. 16;

FIG. 18 is a simplified flow diagram of at least one embodiment of a method for programming an accelerated memory lookup that may be executed by the computing device of FIGS. 16-17;

FIG. 19 is a simplified flow diagram of at least one embodiment of a method for performing an accelerated memory lookup that may be executed by the computing device of FIGS. 16-17;

FIG. 20 is a schematic diagram illustrating an example accelerated memory lookup that may be performed by the system of FIGS. 16-19; and

FIG. 21 is a schematic diagram illustrating an example accelerated chained memory lookup that may be performed by the system of FIGS. 16-19.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

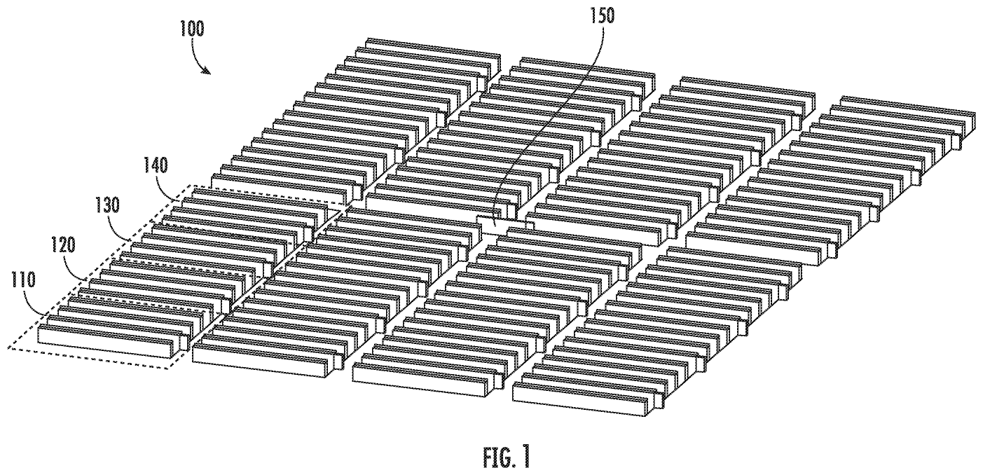

Referring now to FIG. 1, a data center 100 in which disaggregated resources may cooperatively execute one or more workloads (e.g., applications on behalf of customers) includes multiple pods 110, 120, 130, 140, each of which includes one or more rows of racks. Of course, although data center 100 is shown with multiple pods, in some embodiments, the data center 100 may be embodied as a single pod. As described in more detail herein, each rack houses multiple sleds, each of which may be primarily equipped with a particular type of resource (e.g., memory devices, data storage devices, accelerator devices, general purpose processors), i.e., resources that can be logically coupled to form a composed node, which can act as, for example, a server. In the illustrative embodiment, the sleds in each pod 110, 120, 130, 140 are connected to multiple pod switches (e.g., switches that route data communications to and from sleds within the pod). The pod switches, in turn, connect with spine switches 150 that switch communications among pods (e.g., the pods 110, 120, 130, 140) in the data center 100. In some embodiments, the sleds may be connected with a fabric using Intel Omni-Path technology. In other embodiments, the sleds may be connected with other fabrics, such as InfiniBand or Ethernet. As described in more detail herein, resources within sleds in the data center 100 may be allocated to a group (referred to herein as a “managed node”) containing resources from one or more sleds to be collectively utilized in the execution of a workload. The workload can execute as if the resources belonging to the managed node were located on the same sled. The resources in a managed node may belong to sleds belonging to different racks, and even to different pods 110, 120, 130, 140. As such, some resources of a single sled may be allocated to one managed node while other resources of the same sled are allocated to a different managed node (e.g., one processor assigned to one managed node and another processor of the same sled assigned to a different managed node).

A data center comprising disaggregated resources, such as data center 100, can be used in a wide variety of contexts, such as enterprise, government, cloud service provider, and communications service provider (e.g., Telco's), as well in a wide variety of sizes, from cloud service provider mega-data centers that consume over 100,000 sq. ft. to single- or multi-rack installations for use in base stations.

The disaggregation of resources to sleds comprised predominantly of a single type of resource (e.g., compute sleds comprising primarily compute resources, memory sleds containing primarily memory resources), and the selective allocation and deallocation of the disaggregated resources to form a managed node assigned to execute a workload improves the operation and resource usage of the data center 100 relative to typical data centers comprised of hyperconverged servers containing compute, memory, storage and perhaps additional resources in a single chassis. For example, because sleds predominantly contain resources of a particular type, resources of a given type can be upgraded independently of other resources. Additionally, because different resources types (processors, storage, accelerators, etc.) typically have different refresh rates, greater resource utilization and reduced total cost of ownership may be achieved. For example, a data center operator can upgrade the processors throughout their facility by only swapping out the compute sleds. In such a case, accelerator and storage resources may not be contemporaneously upgraded and, rather, may be allowed to continue operating until those resources are scheduled for their own refresh. Resource utilization may also increase. For example, if managed nodes are composed based on requirements of the workloads that will be running on them, resources within a node are more likely to be fully utilized. Such utilization may allow for more managed nodes to run in a data center with a given set of resources, or for a data center expected to run a given set of workloads, to be built using fewer resources.

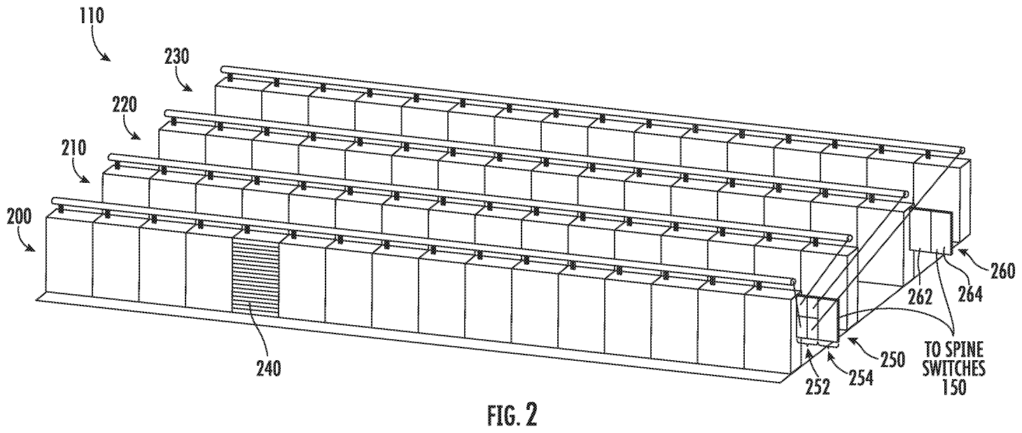

Referring now to FIG. 2, the pod 110, in the illustrative embodiment, includes a set of rows 200, 210, 220, 230 of racks 240. Each rack 240 may house multiple sleds (e.g., sixteen sleds) and provide power and data connections to the housed sleds, as described in more detail herein. In the illustrative embodiment, the racks in each row 200, 210, 220, 230 are connected to multiple pod switches 250, 260. The pod switch 250 includes a set of ports 252 to which the sleds of the racks of the pod 110 are connected and another set of ports 254 that connect the pod 110 to the spine switches 150 to provide connectivity to other pods in the data center 100. Similarly, the pod switch 260 includes a set of ports 262 to which the sleds of the racks of the pod 110 are connected and a set of ports 264 that connect the pod 110 to the spine switches 150. As such, the use of the pair of switches 250, 260 provides an amount of redundancy to the pod 110. For example, if either of the switches 250, 260 fails, the sleds in the pod 110 may still maintain data communication with the remainder of the data center 100 (e.g., sleds of other pods) through the other switch 250, 260. Furthermore, in the illustrative embodiment, the switches 150, 250, 260 may be embodied as dual-mode optical switches, capable of routing both Ethernet protocol communications carrying Internet Protocol (IP) packets and communications according to a second, high-performance link-layer protocol (e.g., Intel's Omni-Path Architecture's, InfiniBand, PCI Express) via optical signaling media of an optical fabric.

It should be appreciated that each of the other pods 120, 130, 140 (as well as any additional pods of the data center 100) may be similarly structured as, and have components similar to, the pod 110 shown in and described in regard to FIG. 2 (e.g., each pod may have rows of racks housing multiple sleds as described above). Additionally, while two pod switches 250, 260 are shown, it should be understood that in other embodiments, each pod 110, 120, 130, 140 may be connected to a different number of pod switches, providing even more failover capacity. Of course, in other embodiments, pods may be arranged differently than the rows-of-racks configuration shown in FIGS. 1-2. For example, a pod may be embodied as multiple sets of racks in which each set of racks is arranged radially, i.e., the racks are equidistant from a center switch.

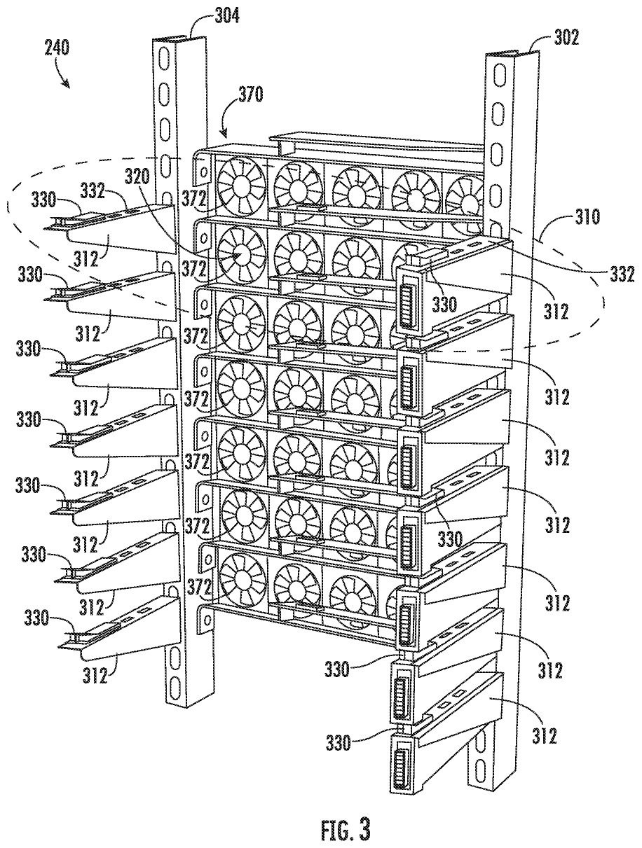

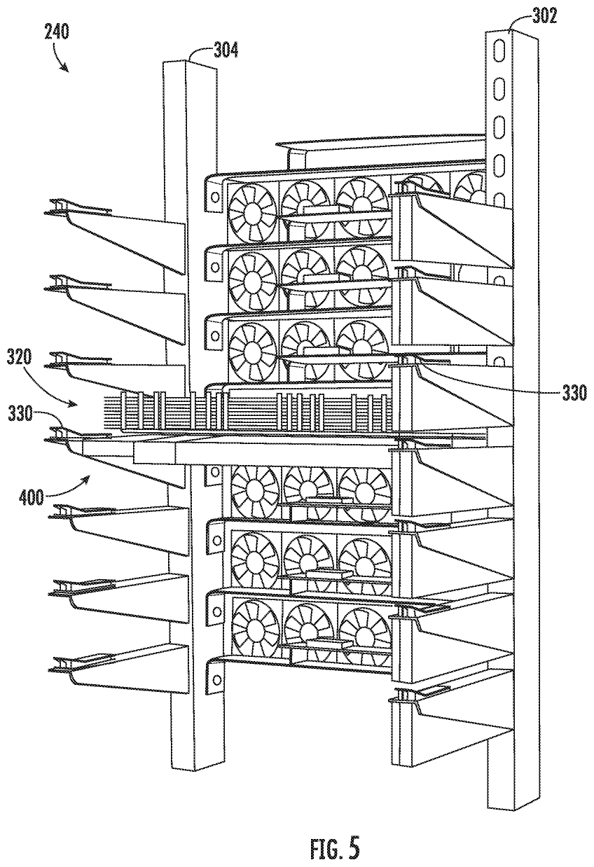

Referring now to FIGS. 3-5, each illustrative rack 240 of the data center 100 includes two elongated support posts 302, 304, which are arranged vertically. For example, the elongated support posts 302, 304 may extend upwardly from a floor of the data center 100 when deployed. The rack 240 also includes one or more horizontal pairs 310 of elongated support arms 312 (identified in FIG. 3 via a dashed ellipse) configured to support a sled of the data center 100 as discussed below. One elongated support arm 312 of the pair of elongated support arms 312 extends outwardly from the elongated support post 302 and the other elongated support arm 312 extends outwardly from the elongated support post 304.

In the illustrative embodiments, each sled of the data center 100 is embodied as a chassis-less sled. That is, each sled has a chassis-less circuit board substrate on which physical resources (e.g., processors, memory, accelerators, storage, etc.) are mounted as discussed in more detail below. As such, the rack 240 is configured to receive the chassis-less sleds. For example, each pair 310 of elongated support arms 312 defines a sled slot 320 of the rack 240, which is configured to receive a corresponding chassis-less sled. To do so, each illustrative elongated support arm 312 includes a circuit board guide 330 configured to receive the chassis-less circuit board substrate of the sled. Each circuit board guide 330 is secured to, or otherwise mounted to, a top side 332 of the corresponding elongated support arm 312. For example, in the illustrative embodiment, each circuit board guide 330 is mounted at a distal end of the corresponding elongated support arm 312 relative to the corresponding elongated support post 302, 304. For clarity of the Figures, not every circuit board guide 330 may be referenced in each Figure.

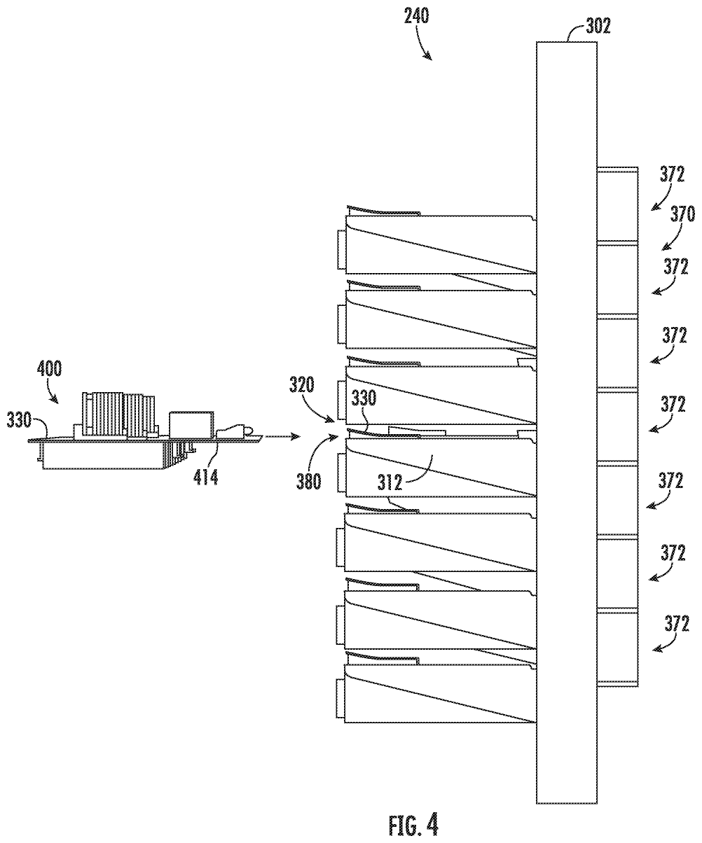

Each circuit board guide 330 includes an inner wall that defines a circuit board slot 380 configured to receive the chassis-less circuit board substrate of a sled 400 when the sled 400 is received in the corresponding sled slot 320 of the rack 240. To do so, as shown in FIG. 4, a user (or robot) aligns the chassis-less circuit board substrate of an illustrative chassis-less sled 400 to a sled slot 320. The user, or robot, may then slide the chassis-less circuit board substrate forward into the sled slot 320 such that each side edge 414 of the chassis-less circuit board substrate is received in a corresponding circuit board slot 380 of the circuit board guides 330 of the pair 310 of elongated support arms 312 that define the corresponding sled slot 320 as shown in FIG. 4. By having robotically accessible and robotically manipulable sleds comprising disaggregated resources, each type of resource can be upgraded independently of each other and at their own optimized refresh rate. Furthermore, the sleds are configured to blindly mate with power and data communication cables in each rack 240, enhancing their ability to be quickly removed, upgraded, reinstalled, and/or replaced. As such, in some embodiments, the data center 100 may operate (e.g., execute workloads, undergo maintenance and/or upgrades, etc.) without human involvement on the data center floor. In other embodiments, a human may facilitate one or more maintenance or upgrade operations in the data center 100.

It should be appreciated that each circuit board guide 330 is dual sided. That is, each circuit board guide 330 includes an inner wall that defines a circuit board slot 380 on each side of the circuit board guide 330. In this way, each circuit board guide 330 can support a chassis-less circuit board substrate on either side. As such, a single additional elongated support post may be added to the rack 240 to turn the rack 240 into a two-rack solution that can hold twice as many sled slots 320 as shown in FIG. 3. The illustrative rack 240 includes seven pairs 310 of elongated support arms 312 that define a corresponding seven sled slots 320, each configured to receive and support a corresponding sled 400 as discussed above. Of course, in other embodiments, the rack 240 may include additional or fewer pairs 310 of elongated support arms 312 (i.e., additional or fewer sled slots 320). It should be appreciated that because the sled 400 is chassis-less, the sled 400 may have an overall height that is different than typical servers. As such, in some embodiments, the height of each sled slot 320 may be shorter than the height of a typical server (e.g., shorter than a single rank unit, “1U”). That is, the vertical distance between each pair 310 of elongated support arms 312 may be less than a standard rack unit “1U.” Additionally, due to the relative decrease in height of the sled slots 320, the overall height of the rack 240 in some embodiments may be shorter than the height of traditional rack enclosures. For example, in some embodiments, each of the elongated support posts 302, 304 may have a length of six feet or less. Again, in other embodiments, the rack 240 may have different dimensions. For example, in some embodiments, the vertical distance between each pair 310 of elongated support arms 312 may be greater than a standard rack until “1U”. In such embodiments, the increased vertical distance between the sleds allows for larger heat sinks to be attached to the physical resources and for larger fans to be used (e.g., in the fan array 370 described below) for cooling each sled, which in turn can allow the physical resources to operate at increased power levels. Further, it should be appreciated that the rack 240 does not include any walls, enclosures, or the like. Rather, the rack 240 is an enclosure-less rack that is opened to the local environment. Of course, in some cases, an end plate may be attached to one of the elongated support posts 302, 304 in those situations in which the rack 240 forms an end-of-row rack in the data center 100.

In some embodiments, various interconnects may be routed upwardly or downwardly through the elongated support posts 302, 304. To facilitate such routing, each elongated support post 302, 304 includes an inner wall that defines an inner chamber in which interconnects may be located. The interconnects routed through the elongated support posts 302, 304 may be embodied as any type of interconnects including, but not limited to, data or communication interconnects to provide communication connections to each sled slot 320, power interconnects to provide power to each sled slot 320, and/or other types of interconnects.

The rack 240, in the illustrative embodiment, includes a support platform on which a corresponding optical data connector (not shown) is mounted. Each optical data connector is associated with a corresponding sled slot 320 and is configured to mate with an optical data connector of a corresponding sled 400 when the sled 400 is received in the corresponding sled slot 320. In some embodiments, optical connections between components (e.g., sleds, racks, and switches) in the data center 100 are made with a blind mate optical connection. For example, a door on each cable may prevent dust from contaminating the fiber inside the cable. In the process of connecting to a blind mate optical connector mechanism, the door is pushed open when the end of the cable approaches or enters the connector mechanism. Subsequently, the optical fiber inside the cable may enter a gel within the connector mechanism and the optical fiber of one cable comes into contact with the optical fiber of another cable within the gel inside the connector mechanism.

The illustrative rack 240 also includes a fan array 370 coupled to the cross-support arms of the rack 240. The fan array 370 includes one or more rows of cooling fans 372, which are aligned in a horizontal line between the elongated support posts 302, 304. In the illustrative embodiment, the fan array 370 includes a row of cooling fans 372 for each sled slot 320 of the rack 240. As discussed above, each sled 400 does not include any on-board cooling system in the illustrative embodiment and, as such, the fan array 370 provides cooling for each sled 400 received in the rack 240. Each rack 240, in the illustrative embodiment, also includes a power supply associated with each sled slot 320. Each power supply is secured to one of the elongated support arms 312 of the pair 310 of elongated support arms 312 that define the corresponding sled slot 320. For example, the rack 240 may include a power supply coupled or secured to each elongated support arm 312 extending from the elongated support post 302. Each power supply includes a power connector configured to mate with a power connector of the sled 400 when the sled 400 is received in the corresponding sled slot 320. In the illustrative embodiment, the sled 400 does not include any on-board power supply and, as such, the power supplies provided in the rack 240 supply power to corresponding sleds 400 when mounted to the rack 240. Each power supply is configured to satisfy the power requirements for its associated sled, which can vary from sled to sled. Additionally, the power supplies provided in the rack 240 can operate independent of each other. That is, within a single rack, a first power supply providing power to a compute sled can provide power levels that are different than power levels supplied by a second power supply providing power to an accelerator sled. The power supplies may be controllable at the sled level or rack level, and may be controlled locally by components on the associated sled or remotely, such as by another sled or an orchestrator.

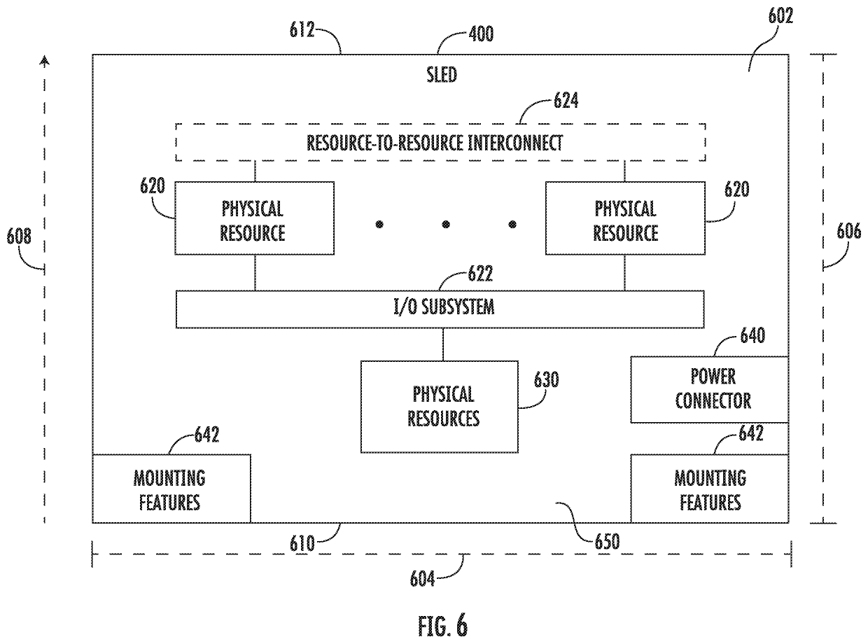

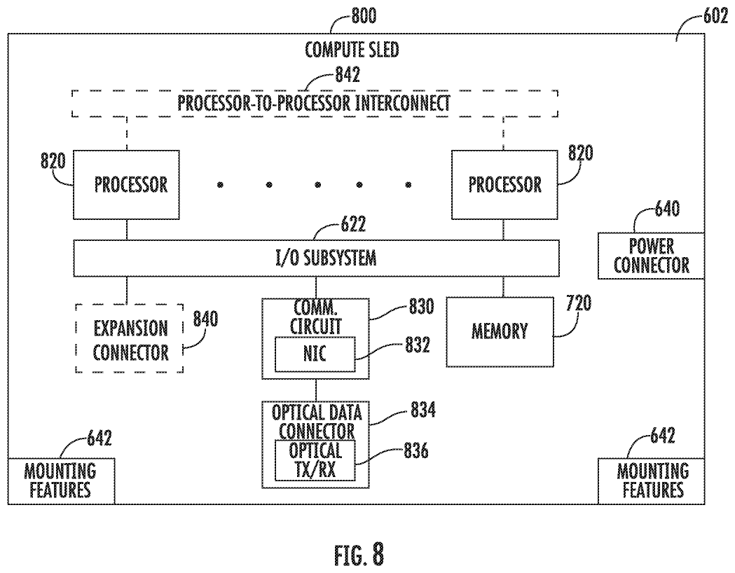

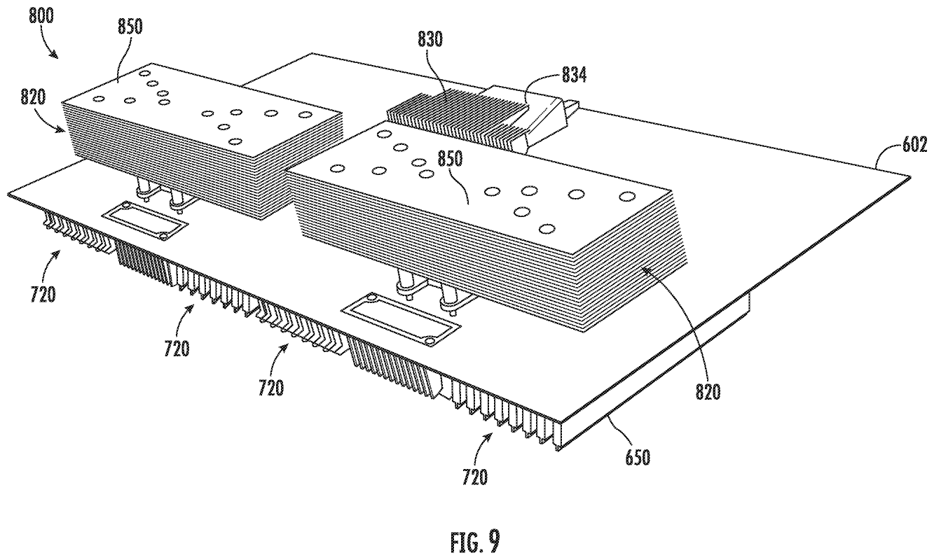

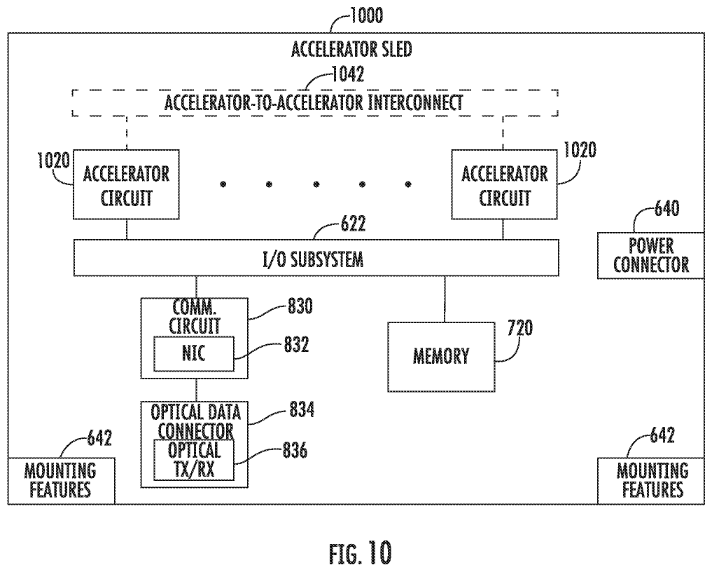

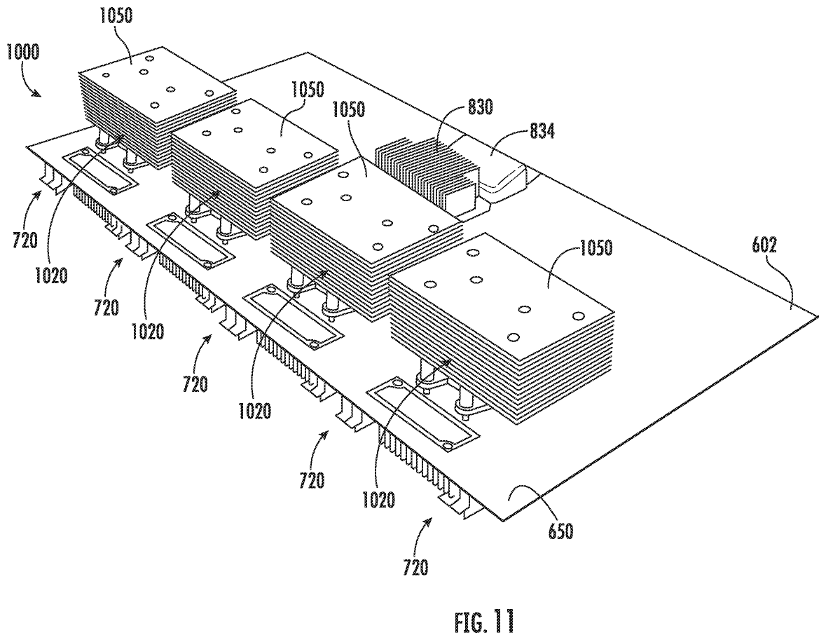

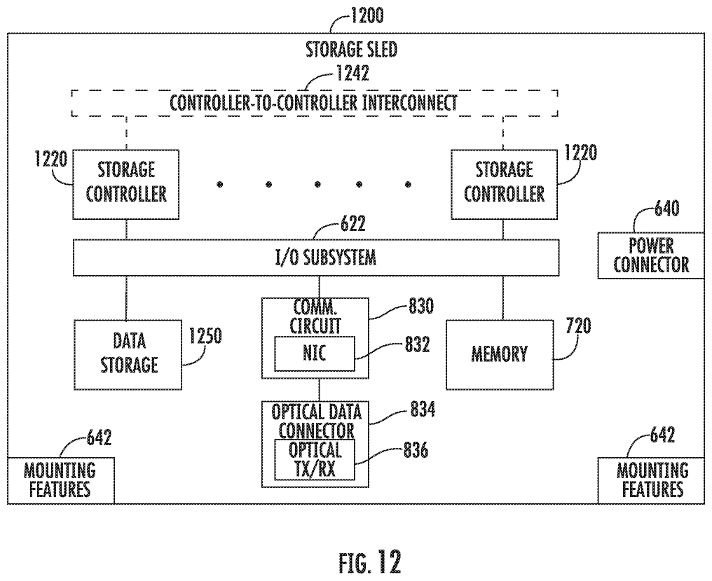

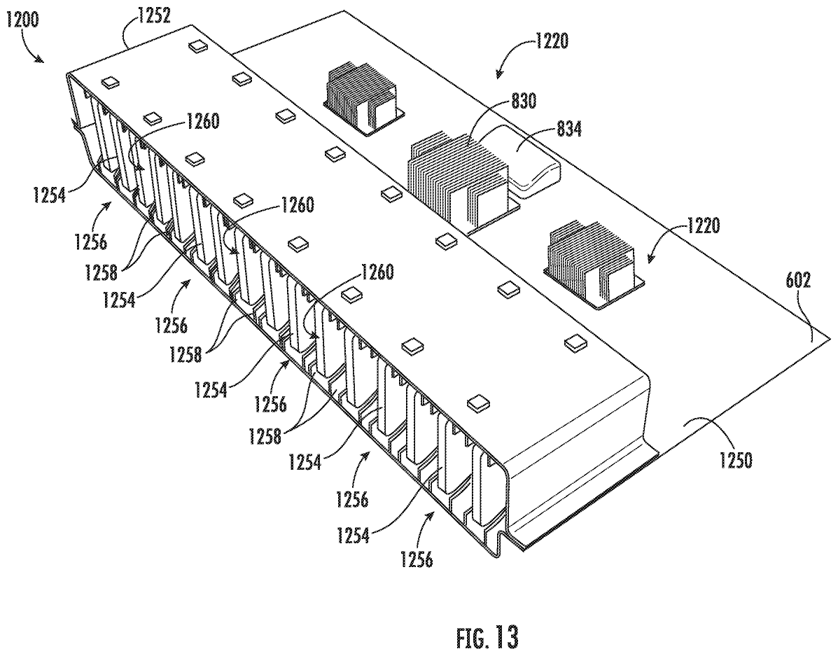

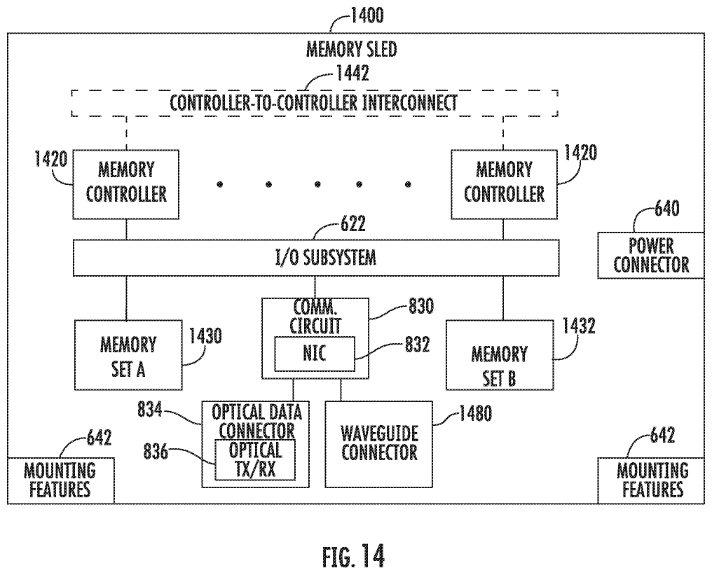

Referring now to FIG. 6, the sled 400, in the illustrative embodiment, is configured to be mounted in a corresponding rack 240 of the data center 100 as discussed above. In some embodiments, each sled 400 may be optimized or otherwise configured for performing particular tasks, such as compute tasks, acceleration tasks, data storage tasks, etc. For example, the sled 400 may be embodied as a compute sled 800 as discussed below in regard to FIGS. 8-9, an accelerator sled 1000 as discussed below in regard to FIGS. 10-11, a storage sled 1200 as discussed below in regard to FIGS. 12-13, or as a sled optimized or otherwise configured to perform other specialized tasks, such as a memory sled 1400, discussed below in regard to FIG. 14.

As discussed above, the illustrative sled 400 includes a chassis-less circuit board substrate 602, which supports various physical resources (e.g., electrical components) mounted thereon. It should be appreciated that the circuit board substrate 602 is “chassis-less” in that the sled 400 does not include a housing or enclosure. Rather, the chassis-less circuit board substrate 602 is open to the local environment. The chassis-less circuit board substrate 602 may be formed from any material capable of supporting the various electrical components mounted thereon. For example, in an illustrative embodiment, the chassis-less circuit board substrate 602 is formed from an FR-4 glass-reinforced epoxy laminate material. Of course, other materials may be used to form the chassis-less circuit board substrate 602 in other embodiments.

As discussed in more detail below, the chassis-less circuit board substrate 602 includes multiple features that improve the thermal cooling characteristics of the various electrical components mounted on the chassis-less circuit board substrate 602. As discussed, the chassis-less circuit board substrate 602 does not include a housing or enclosure, which may improve the airflow over the electrical components of the sled 400 by reducing those structures that may inhibit air flow. For example, because the chassis-less circuit board substrate 602 is not positioned in an individual housing or enclosure, there is no vertically-arranged backplane (e.g., a backplate of the chassis) attached to the chassis-less circuit board substrate 602, which could inhibit air flow across the electrical components. Additionally, the chassis-less circuit board substrate 602 has a geometric shape configured to reduce the length of the airflow path across the electrical components mounted to the chassis-less circuit board substrate 602. For example, the illustrative chassis-less circuit board substrate 602 has a width 604 that is greater than a depth 606 of the chassis-less circuit board substrate 602. In one particular embodiment, for example, the chassis-less circuit board substrate 602 has a width of about 21 inches and a depth of about 9 inches, compared to a typical server that has a width of about 17 inches and a depth of about 39 inches. As such, an airflow path 608 that extends from a front edge 610 of the chassis-less circuit board substrate 602 toward a rear edge 612 has a shorter distance relative to typical servers, which may improve the thermal cooling characteristics of the sled 400. Furthermore, although not illustrated in FIG. 6, the various physical resources mounted to the chassis-less circuit board substrate 602 are mounted in corresponding locations such that no two substantively heat-producing electrical components shadow each other as discussed in more detail below. That is, no two electrical components, which produce appreciable heat during operation (i.e., greater than a nominal heat sufficient enough to adversely impact the cooling of another electrical component), are mounted to the chassis-less circuit board substrate 602 linearly in-line with each other along the direction of the airflow path 608 (i.e., along a direction extending from the front edge 610 toward the rear edge 612 of the chassis-less circuit board substrate 602).

As discussed above, the illustrative sled 400 includes one or more physical resources 620 mounted to a top side 650 of the chassis-less circuit board substrate 602. Although two physical resources 620 are shown in FIG. 6, it should be appreciated that the sled 400 may include one, two, or more physical resources 620 in other embodiments. The physical resources 620 may be embodied as any type of processor, controller, or other compute circuit capable of performing various tasks such as compute functions and/or controlling the functions of the sled 400 depending on, for example, the type or intended functionality of the sled 400. For example, as discussed in more detail below, the physical resources 620 may be embodied as high-performance processors in embodiments in which the sled 400 is embodied as a compute sled, as accelerator co-processors or circuits in embodiments in which the sled 400 is embodied as an accelerator sled, storage controllers in embodiments in which the sled 400 is embodied as a storage sled, or a set of memory devices in embodiments in which the sled 400 is embodied as a memory sled.

The sled 400 also includes one or more additional physical resources 630 mounted to the top side 650 of the chassis-less circuit board substrate 602. In the illustrative embodiment, the additional physical resources include a network interface controller (NIC) as discussed in more detail below. Of course, depending on the type and functionality of the sled 400, the physical resources 630 may include additional or other electrical components, circuits, and/or devices in other embodiments.

The physical resources 620 are communicatively coupled to the physical resources 630 via an input/output (I/O) subsystem 622. The I/O subsystem 622 may be embodied as circuitry and/or components to facilitate input/output operations with the physical resources 620, the physical resources 630, and/or other components of the sled 400. For example, the I/O subsystem 622 may be embodied as, or otherwise include, memory controller hubs, input/output control hubs, integrated sensor hubs, firmware devices, communication links (e.g., point-to-point links, bus links, wires, cables, waveguides, light guides, printed circuit board traces, etc.), and/or other components and subsystems to facilitate the input/output operations. In the illustrative embodiment, the I/O subsystem 622 is embodied as, or otherwise includes, a double data rate 4 (DDR4) data bus or a DDR5 data bus.

In some embodiments, the sled 400 may also include a resource-to-resource interconnect 624. The resource-to-resource interconnect 624 may be embodied as any type of communication interconnect capable of facilitating resource-to-resource communications. In the illustrative embodiment, the resource-to-resource interconnect 624 is embodied as a high-speed point-to-point interconnect (e.g., faster than the I/O subsystem 622). For example, the resource-to-resource interconnect 624 may be embodied as a QuickPath Interconnect (QPI), an UltraPath Interconnect (UPI), or other high-speed point-to-point interconnect dedicated to resource-to-resource communications.

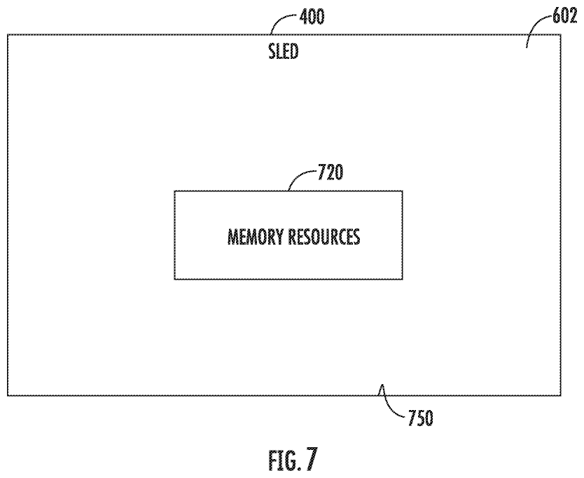

The sled 400 also includes a power connector 640 configured to mate with a corresponding power connector of the rack 240 when the sled 400 is mounted in the corresponding rack 240. The sled 400 receives power from a power supply of the rack 240 via the power connector 640 to supply power to the various electrical components of the sled 400. That is, the sled 400 does not include any local power supply (i.e., an on-board power supply) to provide power to the electrical components of the sled 400. The exclusion of a local or on-board power supply facilitates the reduction in the overall footprint of the chassis-less circuit board substrate 602, which may increase the thermal cooling characteristics of the various electrical components mounted on the chassis-less circuit board substrate 602 as discussed above. In some embodiments, voltage regulators are placed on a bottom side 750 (see FIG. 7) of the chassis-less circuit board substrate 602 directly opposite of the processors 820 (see FIG. 8), and power is routed from the voltage regulators to the processors 820 by vias extending through the circuit board substrate 602. Such a configuration provides an increased thermal budget, additional current and/or voltage, and better voltage control relative to typical printed circuit boards in which processor power is delivered from a voltage regulator, in part, by printed circuit traces.

In some embodiments, the sled 400 may also include mounting features 642 configured to mate with a mounting arm, or other structure, of a robot to facilitate the placement of the sled 600 in a rack 240 by the robot. The mounting features 642 may be embodied as any type of physical structures that allow the robot to grasp the sled 400 without damaging the chassis-less circuit board substrate 602 or the electrical components mounted thereto. For example, in some embodiments, the mounting features 642 may be embodied as non-conductive pads attached to the chassis-less circuit board substrate 602. In other embodiments, the mounting features may be embodied as brackets, braces, or other similar structures attached to the chassis-less circuit board substrate 602. The particular number, shape, size, and/or make-up of the mounting feature 642 may depend on the design of the robot configured to manage the sled 400.

Referring now to FIG. 7, in addition to the physical resources 630 mounted on the top side 650 of the chassis-less circuit board substrate 602, the sled 400 also includes one or more memory devices 720 mounted to a bottom side 750 of the chassis-less circuit board substrate 602. That is, the chassis-less circuit board substrate 602 is embodied as a double-sided circuit board. The physical resources 620 are communicatively coupled to the memory devices 720 via the I/O subsystem 622. For example, the physical resources 620 and the memory devices 720 may be communicatively coupled by one or more vias extending through the chassis-less circuit board substrate 602. Each physical resource 620 may be communicatively coupled to a different set of one or more memory devices 720 in some embodiments. Alternatively, in other embodiments, each physical resource 620 may be communicatively coupled to each memory device 720.

The memory devices 720 may be embodied as any type of memory device capable of storing data for the physical resources 620 during operation of the sled 400, such as any type of volatile (e.g., dynamic random access memory (DRAM), etc.) or non-volatile memory. Volatile memory may be a storage medium that requires power to maintain the state of data stored by the medium. Non-limiting examples of volatile memory may include various types of random access memory (RAM), such as dynamic random access memory (DRAM) or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces.

In one embodiment, the memory device is a block addressable memory device, such as those based on NAND or NOR technologies. A memory device may also include next-generation nonvolatile devices, such as Intel 3D XPoint™ memory or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product. In some embodiments, the memory device may comprise a transistor-less stackable cross point architecture in which memory cells sit at the intersection of word lines and bit lines and are individually addressable and in which bit storage is based on a change in bulk resistance.

Referring now to FIG. 8, in some embodiments, the sled 400 may be embodied as a compute sled 800. The compute sled 800 is optimized, or otherwise configured, to perform compute tasks. Of course, as discussed above, the compute sled 800 may rely on other sleds, such as acceleration sleds and/or storage sleds, to perform such compute tasks. The compute sled 800 includes various physical resources (e.g., electrical components) similar to the physical resources of the sled 400, which have been identified in FIG. 8 using the same reference numbers. The description of such components provided above in regard to FIGS. 6 and 7 applies to the corresponding components of the compute sled 800 and is not repeated herein for clarity of the description of the compute sled 800.

In the illustrative compute sled 800, the physical resources 620 are embodied as processors 820. Although only two processors 820 are shown in FIG. 8, it should be appreciated that the compute sled 800 may include additional processors 820 in other embodiments. Illustratively, the processors 820 are embodied as high-performance processors 820 and may be configured to operate at a relatively high power rating. Although the processors 820 generate additional heat operating at power ratings greater than typical processors (which operate at around 155-230 W), the enhanced thermal cooling characteristics of the chassis-less circuit board substrate 602 discussed above facilitate the higher power operation. For example, in the illustrative embodiment, the processors 820 are configured to operate at a power rating of at least 250 W. In some embodiments, the processors 820 may be configured to operate at a power rating of at least 350 W.

In some embodiments, the compute sled 800 may also include a processor-to-processor interconnect 842. Similar to the resource-to-resource interconnect 624 of the sled 400 discussed above, the processor-to-processor interconnect 842 may be embodied as any type of communication interconnect capable of facilitating processor-to-processor interconnect 842 communications. In the illustrative embodiment, the processor-to-processor interconnect 842 is embodied as a high-speed point-to-point interconnect (e.g., faster than the I/O subsystem 622). For example, the processor-to-processor interconnect 842 may be embodied as a QuickPath Interconnect (QPI), an UltraPath Interconnect (UPI), or other high-speed point-to-point interconnect dedicated to processor-to-processor communications.

The compute sled 800 also includes a communication circuit 830. The illustrative communication circuit 830 includes a network interface controller (NIC) 832, which may also be referred to as a host fabric interface (HFI). The NIC 832 may be embodied as, or otherwise include, any type of integrated circuit, discrete circuits, controller chips, chipsets, add-in-boards, daughtercards, network interface cards, or other devices that may be used by the compute sled 800 to connect with another compute device (e.g., with other sleds 400). In some embodiments, the NIC 832 may be embodied as part of a system-on-a-chip (SoC) that includes one or more processors, or included on a multichip package that also contains one or more processors. In some embodiments, the NIC 832 may include a local processor (not shown) and/or a local memory (not shown) that are both local to the NIC 832. In such embodiments, the local processor of the NIC 832 may be capable of performing one or more of the functions of the processors 820. Additionally or alternatively, in such embodiments, the local memory of the NIC 832 may be integrated into one or more components of the compute sled at the board level, socket level, chip level, and/or other levels.

The communication circuit 830 is communicatively coupled to an optical data connector 834. The optical data connector 834 is configured to mate with a corresponding optical data connector of the rack 240 when the compute sled 800 is mounted in the rack 240. Illustratively, the optical data connector 834 includes a plurality of optical fibers which lead from a mating surface of the optical data connector 834 to an optical transceiver 836. The optical transceiver 836 is configured to convert incoming optical signals from the rack-side optical data connector to electrical signals and to convert electrical signals to outgoing optical signals to the rack-side optical data connector. Although shown as forming part of the optical data connector 834 in the illustrative embodiment, the optical transceiver 836 may form a portion of the communication circuit 830 in other embodiments.

In some embodiments, the compute sled 800 may also include an expansion connector 840. In such embodiments, the expansion connector 840 is configured to mate with a corresponding connector of an expansion chassis-less circuit board substrate to provide additional physical resources to the compute sled 800. The additional physical resources may be used, for example, by the processors 820 during operation of the compute sled 800. The expansion chassis-less circuit board substrate may be substantially similar to the chassis-less circuit board substrate 602 discussed above and may include various electrical components mounted thereto. The particular electrical components mounted to the expansion chassis-less circuit board substrate may depend on the intended functionality of the expansion chassis-less circuit board substrate. For example, the expansion chassis-less circuit board substrate may provide additional compute resources, memory resources, and/or storage resources. As such, the additional physical resources of the expansion chassis-less circuit board substrate may include, but is not limited to, processors, memory devices, storage devices, and/or accelerator circuits including, for example, field programmable gate arrays (FPGA), application-specific integrated circuits (ASICs), security co-processors, graphics processing units (GPUs), machine learning circuits, or other specialized processors, controllers, devices, and/or circuits.

Referring now to FIG. 9, an illustrative embodiment of the compute sled 800 is shown. As shown, the processors 820, communication circuit 830, and optical data connector 834 are mounted to the top side 650 of the chassis-less circuit board substrate 602. Any suitable attachment or mounting technology may be used to mount the physical resources of the compute sled 800 to the chassis-less circuit board substrate 602. For example, the various physical resources may be mounted in corresponding sockets (e.g., a processor socket), holders, or brackets. In some cases, some of the electrical components may be directly mounted to the chassis-less circuit board substrate 602 via soldering or similar techniques.

As discussed above, the individual processors 820 and communication circuit 830 are mounted to the top side 650 of the chassis-less circuit board substrate 602 such that no two heat-producing, electrical components shadow each other. In the illustrative embodiment, the processors 820 and communication circuit 830 are mounted in corresponding locations on the top side 650 of the chassis-less circuit board substrate 602 such that no two of those physical resources are linearly in-line with others along the direction of the airflow path 608. It should be appreciated that, although the optical data connector 834 is in-line with the communication circuit 830, the optical data connector 834 produces no or nominal heat during operation.

The memory devices 720 of the compute sled 800 are mounted to the bottom side 750 of the of the chassis-less circuit board substrate 602 as discussed above in regard to the sled 400. Although mounted to the bottom side 750, the memory devices 720 are communicatively coupled to the processors 820 located on the top side 650 via the I/O subsystem 622. Because the chassis-less circuit board substrate 602 is embodied as a double-sided circuit board, the memory devices 720 and the processors 820 may be communicatively coupled by one or more vias, connectors, or other mechanisms extending through the chassis-less circuit board substrate 602. Of course, each processor 820 may be communicatively coupled to a different set of one or more memory devices 720 in some embodiments. Alternatively, in other embodiments, each processor 820 may be communicatively coupled to each memory device 720. In some embodiments, the memory devices 720 may be mounted to one or more memory mezzanines on the bottom side of the chassis-less circuit board substrate 602 and may interconnect with a corresponding processor 820 through a ball-grid array.

Each of the processors 820 includes a heatsink 850 secured thereto. Due to the mounting of the memory devices 720 to the bottom side 750 of the chassis-less circuit board substrate 602 (as well as the vertical spacing of the sleds 400 in the corresponding rack 240), the top side 650 of the chassis-less circuit board substrate 602 includes additional “free” area or space that facilitates the use of heatsinks 850 having a larger size relative to traditional heatsinks used in typical servers. Additionally, due to the improved thermal cooling characteristics of the chassis-less circuit board substrate 602, none of the processor heatsinks 850 include cooling fans attached thereto. That is, each of the heatsinks 850 is embodied as a fan-less heatsink. In some embodiments, the heat sinks 850 mounted atop the processors 820 may overlap with the heat sink attached to the communication circuit 830 in the direction of the airflow path 608 due to their increased size, as illustratively suggested by FIG. 9.

Referring now to FIG. 10, in some embodiments, the sled 400 may be embodied as an accelerator sled 1000. The accelerator sled 1000 is configured, to perform specialized compute tasks, such as machine learning, encryption, hashing, or other computational-intensive task. In some embodiments, for example, a compute sled 800 may offload tasks to the accelerator sled 1000 during operation. The accelerator sled 1000 includes various components similar to components of the sled 400 and/or compute sled 800, which have been identified in FIG. 10 using the same reference numbers. The description of such components provided above in regard to FIGS. 6, 7, and 8 apply to the corresponding components of the accelerator sled 1000 and is not repeated herein for clarity of the description of the accelerator sled 1000.

In the illustrative accelerator sled 1000, the physical resources 620 are embodied as accelerator circuits 1020. Although only two accelerator circuits 1020 are shown in FIG. 10, it should be appreciated that the accelerator sled 1000 may include additional accelerator circuits 1020 in other embodiments. For example, as shown in FIG. 11, the accelerator sled 1000 may include four accelerator circuits 1020 in some embodiments. The accelerator circuits 1020 may be embodied as any type of processor, co-processor, compute circuit, or other device capable of performing compute or processing operations. For example, the accelerator circuits 1020 may be embodied as, for example, field programmable gate arrays (FPGA), application-specific integrated circuits (ASICs), security co-processors, graphics processing units (GPUs), neuromorphic processor units, quantum computers, machine learning circuits, or other specialized processors, controllers, devices, and/or circuits.

In some embodiments, the accelerator sled 1000 may also include an accelerator-to-accelerator interconnect 1042. Similar to the resource-to-resource interconnect 624 of the sled 600 discussed above, the accelerator-to-accelerator interconnect 1042 may be embodied as any type of communication interconnect capable of facilitating accelerator-to-accelerator communications. In the illustrative embodiment, the accelerator-to-accelerator interconnect 1042 is embodied as a high-speed point-to-point interconnect (e.g., faster than the I/O subsystem 622). For example, the accelerator-to-accelerator interconnect 1042 may be embodied as a QuickPath Interconnect (QPI), an UltraPath Interconnect (UPI), or other high-speed point-to-point interconnect dedicated to processor-to-processor communications. In some embodiments, the accelerator circuits 1020 may be daisy-chained with a primary accelerator circuit 1020 connected to the NIC 832 and memory 720 through the I/O subsystem 622 and a secondary accelerator circuit 1020 connected to the NIC 832 and memory 720 through a primary accelerator circuit 1020.

Referring now to FIG. 11, an illustrative embodiment of the accelerator sled 1000 is shown. As discussed above, the accelerator circuits 1020, communication circuit 830, and optical data connector 834 are mounted to the top side 650 of the chassis-less circuit board substrate 602. Again, the individual accelerator circuits 1020 and communication circuit 830 are mounted to the top side 650 of the chassis-less circuit board substrate 602 such that no two heat-producing, electrical components shadow each other as discussed above. The memory devices 720 of the accelerator sled 1000 are mounted to the bottom side 750 of the of the chassis-less circuit board substrate 602 as discussed above in regard to the sled 600. Although mounted to the bottom side 750, the memory devices 720 are communicatively coupled to the accelerator circuits 1020 located on the top side 650 via the I/O subsystem 622 (e.g., through vias). Further, each of the accelerator circuits 1020 may include a heatsink 1070 that is larger than a traditional heatsink used in a server. As discussed above with reference to the heatsinks 870, the heatsinks 1070 may be larger than traditional heatsinks because of the “free” area provided by the memory resources 720 being located on the bottom side 750 of the chassis-less circuit board substrate 602 rather than on the top side 650.

Referring now to FIG. 12, in some embodiments, the sled 400 may be embodied as a storage sled 1200. The storage sled 1200 is configured, to store data in a data storage 1250 local to the storage sled 1200. For example, during operation, a compute sled 800 or an accelerator sled 1000 may store and retrieve data from the data storage 1250 of the storage sled 1200. The storage sled 1200 includes various components similar to components of the sled 400 and/or the compute sled 800, which have been identified in FIG. 12 using the same reference numbers. The description of such components provided above in regard to FIGS. 6, 7, and 8 apply to the corresponding components of the storage sled 1200 and is not repeated herein for clarity of the description of the storage sled 1200.

In the illustrative storage sled 1200, the physical resources 620 are embodied as storage controllers 1220. Although only two storage controllers 1220 are shown in FIG. 12, it should be appreciated that the storage sled 1200 may include additional storage controllers 1220 in other embodiments. The storage controllers 1220 may be embodied as any type of processor, controller, or control circuit capable of controlling the storage and retrieval of data into the data storage 1250 based on requests received via the communication circuit 830. In the illustrative embodiment, the storage controllers 1220 are embodied as relatively low-power processors or controllers. For example, in some embodiments, the storage controllers 1220 may be configured to operate at a power rating of about 75 watts.

In some embodiments, the storage sled 1200 may also include a controller-to-controller interconnect 1242. Similar to the resource-to-resource interconnect 624 of the sled 400 discussed above, the controller-to-controller interconnect 1242 may be embodied as any type of communication interconnect capable of facilitating controller-to-controller communications. In the illustrative embodiment, the controller-to-controller interconnect 1242 is embodied as a high-speed point-to-point interconnect (e.g., faster than the I/O subsystem 622). For example, the controller-to-controller interconnect 1242 may be embodied as a QuickPath Interconnect (QPI), an UltraPath Interconnect (UPI), or other high-speed point-to-point interconnect dedicated to processor-to-processor communications.

Referring now to FIG. 13, an illustrative embodiment of the storage sled 1200 is shown. In the illustrative embodiment, the data storage 1250 is embodied as, or otherwise includes, a storage cage 1252 configured to house one or more solid state drives (SSDs) 1254. To do so, the storage cage 1252 includes a number of mounting slots 1256, each of which is configured to receive a corresponding solid state drive 1254. Each of the mounting slots 1256 includes a number of drive guides 1258 that cooperate to define an access opening 1260 of the corresponding mounting slot 1256. The storage cage 1252 is secured to the chassis-less circuit board substrate 602 such that the access openings face away from (i.e., toward the front of) the chassis-less circuit board substrate 602. As such, solid state drives 1254 are accessible while the storage sled 1200 is mounted in a corresponding rack 204. For example, a solid state drive 1254 may be swapped out of a rack 240 (e.g., via a robot) while the storage sled 1200 remains mounted in the corresponding rack 240.

The storage cage 1252 illustratively includes sixteen mounting slots 1256 and is capable of mounting and storing sixteen solid state drives 1254. Of course, the storage cage 1252 may be configured to store additional or fewer solid state drives 1254 in other embodiments. Additionally, in the illustrative embodiment, the solid state drivers are mounted vertically in the storage cage 1252, but may be mounted in the storage cage 1252 in a different orientation in other embodiments. Each solid state drive 1254 may be embodied as any type of data storage device capable of storing long term data. To do so, the solid state drives 1254 may include volatile and non-volatile memory devices discussed above.

As shown in FIG. 13, the storage controllers 1220, the communication circuit 830, and the optical data connector 834 are illustratively mounted to the top side 650 of the chassis-less circuit board substrate 602. Again, as discussed above, any suitable attachment or mounting technology may be used to mount the electrical components of the storage sled 1200 to the chassis-less circuit board substrate 602 including, for example, sockets (e.g., a processor socket), holders, brackets, soldered connections, and/or other mounting or securing techniques.

As discussed above, the individual storage controllers 1220 and the communication circuit 830 are mounted to the top side 650 of the chassis-less circuit board substrate 602 such that no two heat-producing, electrical components shadow each other. For example, the storage controllers 1220 and the communication circuit 830 are mounted in corresponding locations on the top side 650 of the chassis-less circuit board substrate 602 such that no two of those electrical components are linearly in-line with each other along the direction of the airflow path 608.

The memory devices 720 of the storage sled 1200 are mounted to the bottom side 750 of the of the chassis-less circuit board substrate 602 as discussed above in regard to the sled 400. Although mounted to the bottom side 750, the memory devices 720 are communicatively coupled to the storage controllers 1220 located on the top side 650 via the I/O subsystem 622. Again, because the chassis-less circuit board substrate 602 is embodied as a double-sided circuit board, the memory devices 720 and the storage controllers 1220 may be communicatively coupled by one or more vias, connectors, or other mechanisms extending through the chassis-less circuit board substrate 602. Each of the storage controllers 1220 includes a heatsink 1270 secured thereto. As discussed above, due to the improved thermal cooling characteristics of the chassis-less circuit board substrate 602 of the storage sled 1200, none of the heatsinks 1270 include cooling fans attached thereto. That is, each of the heatsinks 1270 is embodied as a fan-less heatsink.

Referring now to FIG. 14, in some embodiments, the sled 400 may be embodied as a memory sled 1400. The storage sled 1400 is optimized, or otherwise configured, to provide other sleds 400 (e.g., compute sleds 800, accelerator sleds 1000, etc.) with access to a pool of memory (e.g., in two or more sets 1430, 1432 of memory devices 720) local to the memory sled 1200. For example, during operation, a compute sled 800 or an accelerator sled 1000 may remotely write to and/or read from one or more of the memory sets 1430, 1432 of the memory sled 1200 using a logical address space that maps to physical addresses in the memory sets 1430, 1432. The memory sled 1400 includes various components similar to components of the sled 400 and/or the compute sled 800, which have been identified in FIG. 14 using the same reference numbers. The description of such components provided above in regard to FIGS. 6, 7, and 8 apply to the corresponding components of the memory sled 1400 and is not repeated herein for clarity of the description of the memory sled 1400.

In the illustrative memory sled 1400, the physical resources 620 are embodied as memory controllers 1420. Although only two memory controllers 1420 are shown in FIG. 14, it should be appreciated that the memory sled 1400 may include additional memory controllers 1420 in other embodiments. The memory controllers 1420 may be embodied as any type of processor, controller, or control circuit capable of controlling the writing and reading of data into the memory sets 1430, 1432 based on requests received via the communication circuit 830. In the illustrative embodiment, each memory controller 1420 is connected to a corresponding memory set 1430, 1432 to write to and read from memory devices 720 within the corresponding memory set 1430, 1432 and enforce any permissions (e.g., read, write, etc.) associated with sled 400 that has sent a request to the memory sled 1400 to perform a memory access operation (e.g., read or write).

In some embodiments, the memory sled 1400 may also include a controller-to-controller interconnect 1442. Similar to the resource-to-resource interconnect 624 of the sled 400 discussed above, the controller-to-controller interconnect 1442 may be embodied as any type of communication interconnect capable of facilitating controller-to-controller communications. In the illustrative embodiment, the controller-to-controller interconnect 1442 is embodied as a high-speed point-to-point interconnect (e.g., faster than the I/O subsystem 622). For example, the controller-to-controller interconnect 1442 may be embodied as a QuickPath Interconnect (QPI), an UltraPath Interconnect (UPI), or other high-speed point-to-point interconnect dedicated to processor-to-processor communications. As such, in some embodiments, a memory controller 1420 may access, through the controller-to-controller interconnect 1442, memory that is within the memory set 1432 associated with another memory controller 1420. In some embodiments, a scalable memory controller is made of multiple smaller memory controllers, referred to herein as “chiplets”, on a memory sled (e.g., the memory sled 1400). The chiplets may be interconnected (e.g., using EMIB (Embedded Multi-Die Interconnect Bridge)). The combined chiplet memory controller may scale up to a relatively large number of memory controllers and I/O ports, (e.g., up to 16 memory channels). In some embodiments, the memory controllers 1420 may implement a memory interleave (e.g., one memory address is mapped to the memory set 1430, the next memory address is mapped to the memory set 1432, and the third address is mapped to the memory set 1430, etc.). The interleaving may be managed within the memory controllers 1420, or from CPU sockets (e.g., of the compute sled 800) across network links to the memory sets 1430, 1432, and may improve the latency associated with performing memory access operations as compared to accessing contiguous memory addresses from the same memory device.

Further, in some embodiments, the memory sled 1400 may be connected to one or more other sleds 400 (e.g., in the same rack 240 or an adjacent rack 240) through a waveguide, using the waveguide connector 1480. In the illustrative embodiment, the waveguides are 64 millimeter waveguides that provide 16 Rx (i.e., receive) lanes and 16 Tx (i.e., transmit) lanes. Each lane, in the illustrative embodiment, is either 16 GHz or 32 GHz. In other embodiments, the frequencies may be different. Using a waveguide may provide high throughput access to the memory pool (e.g., the memory sets 1430, 1432) to another sled (e.g., a sled 400 in the same rack 240 or an adjacent rack 240 as the memory sled 1400) without adding to the load on the optical data connector 834.

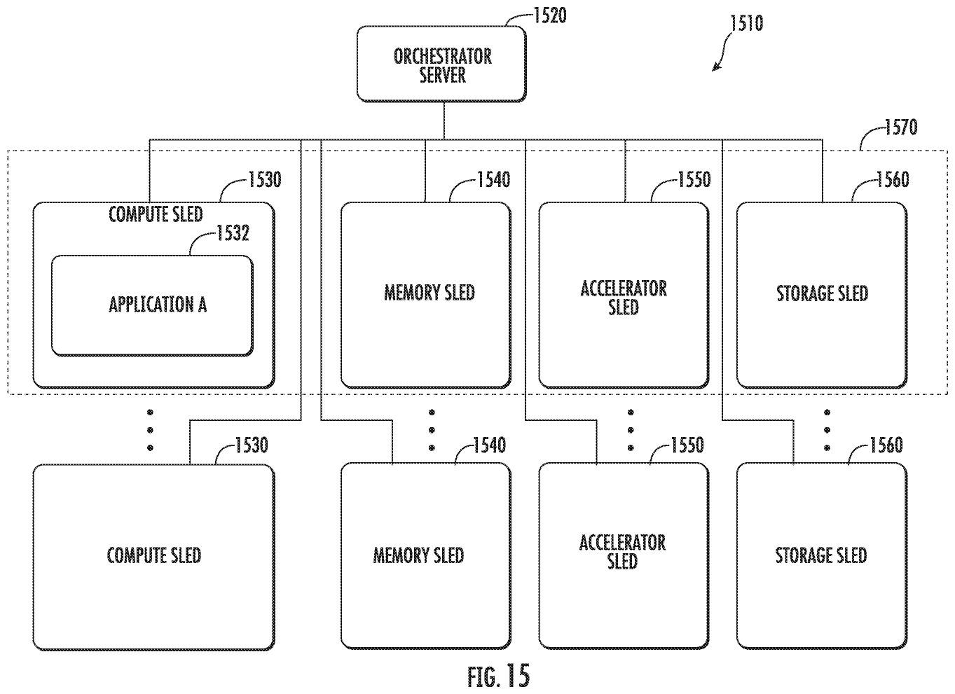

Referring now to FIG. 15, a system for executing one or more workloads (e.g., applications) may be implemented in accordance with the data center 100. In the illustrative embodiment, the system 1510 includes an orchestrator server 1520, which may be embodied as a managed node comprising a compute device (e.g., a processor 820 on a compute sled 800) executing management software (e.g., a cloud operating environment, such as OpenStack) that is communicatively coupled to multiple sleds 400 including a large number of compute sleds 1530 (e.g., each similar to the compute sled 800), memory sleds 1540 (e.g., each similar to the memory sled 1400), accelerator sleds 1550 (e.g., each similar to the memory sled 1000), and storage sleds 1560 (e.g., each similar to the storage sled 1200). One or more of the sleds 1530, 1540, 1550, 1560 may be grouped into a managed node 1570, such as by the orchestrator server 1520, to collectively perform a workload (e.g., an application 1532 executed in a virtual machine or in a container). The managed node 1570 may be embodied as an assembly of physical resources 620, such as processors 820, memory resources 720, accelerator circuits 1020, or data storage 1250, from the same or different sleds 400. Further, the managed node may be established, defined, or “spun up” by the orchestrator server 1520 at the time a workload is to be assigned to the managed node or at any other time, and may exist regardless of whether any workloads are presently assigned to the managed node. In the illustrative embodiment, the orchestrator server 1520 may selectively allocate and/or deallocate physical resources 620 from the sleds 400 and/or add or remove one or more sleds 400 from the managed node 1570 as a function of quality of service (QoS) targets (e.g., performance targets associated with a throughput, latency, instructions per second, etc.) associated with a service level agreement for the workload (e.g., the application 1532). In doing so, the orchestrator server 1520 may receive telemetry data indicative of performance conditions (e.g., throughput, latency, instructions per second, etc.) in each sled 400 of the managed node 1570 and compare the telemetry data to the quality of service targets to determine whether the quality of service targets are being satisfied. The orchestrator server 1520 may additionally determine whether one or more physical resources may be deallocated from the managed node 1570 while still satisfying the QoS targets, thereby freeing up those physical resources for use in another managed node (e.g., to execute a different workload). Alternatively, if the QoS targets are not presently satisfied, the orchestrator server 1520 may determine to dynamically allocate additional physical resources to assist in the execution of the workload (e.g., the application 1532) while the workload is executing. Similarly, the orchestrator server 1520 may determine to dynamically deallocate physical resources from a managed node if the orchestrator server 1520 determines that deallocating the physical resource would result in QoS targets still being met.

Additionally, in some embodiments, the orchestrator server 1520 may identify trends in the resource utilization of the workload (e.g., the application 1532), such as by identifying phases of execution (e.g., time periods in which different operations, each having different resource utilizations characteristics, are performed) of the workload (e.g., the application 1532) and pre-emptively identifying available resources in the data center 100 and allocating them to the managed node 1570 (e.g., within a predefined time period of the associated phase beginning). In some embodiments, the orchestrator server 1520 may model performance based on various latencies and a distribution scheme to place workloads among compute sleds and other resources (e.g., accelerator sleds, memory sleds, storage sleds) in the data center 100. For example, the orchestrator server 1520 may utilize a model that accounts for the performance of resources on the sleds 400 (e.g., FPGA performance, memory access latency, etc.) and the performance (e.g., congestion, latency, bandwidth) of the path through the network to the resource (e.g., FPGA). As such, the orchestrator server 1520 may determine which resource(s) should be used with which workloads based on the total latency associated with each potential resource available in the data center 100 (e.g., the latency associated with the performance of the resource itself in addition to the latency associated with the path through the network between the compute sled executing the workload and the sled 400 on which the resource is located).

In some embodiments, the orchestrator server 1520 may generate a map of heat generation in the data center 100 using telemetry data (e.g., temperatures, fan speeds, etc.) reported from the sleds 400 and allocate resources to managed nodes as a function of the map of heat generation and predicted heat generation associated with different workloads, to maintain a target temperature and heat distribution in the data center 100. Additionally or alternatively, in some embodiments, the orchestrator server 1520 may organize received telemetry data into a hierarchical model that is indicative of a relationship between the managed nodes (e.g., a spatial relationship such as the physical locations of the resources of the managed nodes within the data center 100 and/or a functional relationship, such as groupings of the managed nodes by the customers the managed nodes provide services for, the types of functions typically performed by the managed nodes, managed nodes that typically share or exchange workloads among each other, etc.). Based on differences in the physical locations and resources in the managed nodes, a given workload may exhibit different resource utilizations (e.g., cause a different internal temperature, use a different percentage of processor or memory capacity) across the resources of different managed nodes. The orchestrator server 1520 may determine the differences based on the telemetry data stored in the hierarchical model and factor the differences into a prediction of future resource utilization of a workload if the workload is reassigned from one managed node to another managed node, to accurately balance resource utilization in the data center 100.

To reduce the computational load on the orchestrator server 1520 and the data transfer load on the network, in some embodiments, the orchestrator server 1520 may send self-test information to the sleds 400 to enable each sled 400 to locally (e.g., on the sled 400) determine whether telemetry data generated by the sled 400 satisfies one or more conditions (e.g., an available capacity that satisfies a predefined threshold, a temperature that satisfies a predefined threshold, etc.). Each sled 400 may then report back a simplified result (e.g., yes or no) to the orchestrator server 1520, which the orchestrator server 1520 may utilize in determining the allocation of resources to managed nodes.

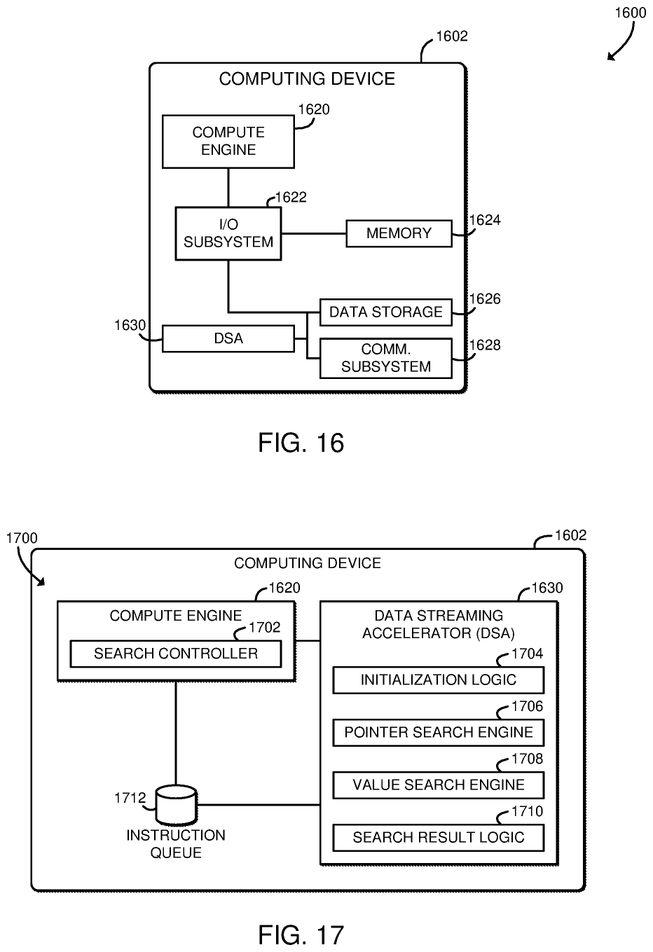

Referring now to FIG. 16, an illustrative system 1600 for hardware accelerated memory lookups includes a computing device 1602 having a compute engine 1620 and a data streaming accelerator (DSA) 1630. In use, the compute engine 1620 programs the DSA 1630 to search for a particular value in a memory region. The compute engine 1620 instructs the DSA 1630 to start the search, and the DSA 1630 searches through memory for a specified value. The DSA 1630 may follow pointers to other memory locations in order to perform chained memory lookups. When the search is complete, the DSA 1630 provides the memory address of the matching value to the compute engine 1620. Thus, the system 1600 may perform hardware-accelerated lookups in memory, which may offload compute cycles from the compute engine 1620 or otherwise reduce usage of the compute engine 1620. For example, during the search, the compute engine 1620 may enter a sleep mode or otherwise reduce power consumption, or the compute engine 1620 may be free to perform other tasks. Additionally, by performing the search with the DSA 1630, the contents of memory are not required to be loaded by the compute engine 1620, which may reduce cache pollution and further increase performance.

The computing device 1602 may be embodied as any type of device capable of performing the functions described herein. For example, the computing device 1602 may be embodied as, without limitation, a sled, a compute sled, an accelerator sled, a storage sled, a computer, a server, a distributed computing device, a disaggregated computing device, a laptop computer, a tablet computer, a notebook computer, a mobile computing device, a smartphone, a wearable computing device, a multiprocessor system, a server, a workstation, and/or a consumer electronic device. As shown in FIG. 1, the illustrative computing device 1602 includes a compute engine 1620, an I/O subsystem 1622, a memory 1624, a data storage device 1626, and a communication subsystem 1628. Additionally, in some embodiments, one or more of the illustrative components may be incorporated in, or otherwise form a portion of, another component. For example, the memory 1624, or portions thereof, may be incorporated in the compute engine 1620 in some embodiments.

The compute engine 1620 may be embodied as any type of compute engine capable of performing the functions described herein. For example, the compute engine 1620 may be embodied as a single or multi-core processor(s), digital signal processor, microcontroller, field-programmable gate array (FPGA), or other configurable circuitry, application-specific integrated circuit (ASIC), or other processor or processing/controlling circuit. Similarly, the memory 1624 may be embodied as any type of volatile, non-volatile, or persistent memory or data storage capable of performing the functions described herein. In operation, the memory 1624 may store various data and software used during operation of the computing device 1602 such as operating systems, applications, programs, libraries, and drivers. As shown, the memory 1624 may be communicatively coupled to the compute engine 1620 via the I/O subsystem 1622, which may be embodied as circuitry and/or components to facilitate input/output operations with the compute engine 1620, the memory 1624, and other components of the computing device 1602. For example, the I/O subsystem 1622 may be embodied as, or otherwise include, memory controller hubs, input/output control hubs, sensor hubs, host controllers, firmware devices, communication links (i.e., point-to-point links, bus links, wires, cables, light guides, printed circuit board traces, etc.) and/or other components and subsystems to facilitate the input/output operations. In some embodiments, the memory 1624 may be directly coupled to the compute engine 1620, for example via an integrated memory controller hub. Additionally, in some embodiments, the I/O subsystem 1622 may form a portion of a system-on-a-chip (SoC) and be incorporated, along with the compute engine 1620, the memory 1624, and/or other components of the computing device 1602, on a single integrated circuit chip.

The data storage device 1626 may be embodied as any type of device or devices configured for short-term or long-term storage of data such as, for example, memory devices and circuits, memory cards, hard disk drives, solid-state drives, non-volatile flash memory, 3D XPoint memory, persistent memory, or other data storage devices. The computing device 1602 may also include a communication subsystem 1628, which may be embodied as any network interface controller (NIC), communication circuit, device, or collection thereof, capable of enabling communications between the computing device 1602 and other remote devices over a computer network (not shown). The communication subsystem 1628 may be configured to use any one or more communication technology (e.g., wired or wireless communications) and associated protocols (e.g., Ethernet, Bluetooth®, Wi-Fi®, WiMAX, 3G, 4G LTE, etc.) to effect such communication.

As shown, the computing device 1602 further includes a DSA 1630. The DSA 1630 may be embodied as any ASIC, FPGA, integrated circuit, functional block, hardware logic, or other hardware accelerator capable of performing the functions described herein. In particular, the DSA 1630 may be programmed by the compute engine 1620 to flexibly accelerate memory operations including memory access operations, memory copy operations, checksum creation or verification, virtual address translation and page fault handling, or other memory operations. The DSA 1630 may be capable of performing multiple operations in a predetermined order or in parallel. As described further below, the compute engine 1620 may program by the DSA 1630 by supplying the DSA 1630 with an instruction queue that describes the operations to be performed, and the DSA 1630 may execute the instruction queue independently of the compute engine 1620. Although illustrated in FIG. 16 as a separate component coupled to the I/O subsystem 1622, it should be understood that in some embodiments the DSA 1630 and/or the functionality provided by the DSA 1630 may be incorporated in one or more other components of the computing device 1602 such as the I/O subsystem 1622, a memory controller, or other component.

Referring now to FIG. 17, in an illustrative embodiment, the computing device 1602 establishes an environment 1700 during operation. The illustrative environment 1700 includes a search controller 1702, initialization logic 1704, a pointer search engine 1706, a value search engine 1708, and search result logic 1710. The various components of the environment 1700 may be embodied as hardware, firmware, software, or a combination thereof. As such, in some embodiments, one or more of the components of the environment 1700 may be embodied as circuitry or collection of electrical devices (e.g., search controller circuitry 1702, initialization logic circuitry 1704, pointer search engine circuitry 1706, value search engine circuitry 1708, and/or search result logic circuitry 1710). It should be appreciated that, in such embodiments, one or more of the search controller circuitry 1702, the initialization logic circuitry 1704, the pointer search engine circuitry 1706, the value search engine circuitry 1708, and/or the search result logic circuitry 1710 may form a portion of the compute engine 1620, the DSA 1630, and/or other components of the computing device 1602. Additionally, in some embodiments, one or more of the illustrative components may form a portion of another component and/or one or more of the illustrative components may be independent of one another.

The search controller 1702 is configured to program, by the compute engine 1620, an instruction queue 1712 for the DSA 1630. The instruction queue 1712 may be embodied as multiple descriptors stored in a memory of the computing device 1602 (e.g., the memory 1624). The instruction queue 1712 is indicative of a memory region start pointer, a record length, and one or more memory location tuples that describe the layout of the memory region to be searched. The search record pointer references a memory of the computing device 1602, which may include volatile memory (e.g., DRAM), non-volatile memory, persistent memory, a data storage device, or other memory location addressable by the DSA 1630. Each memory location tuple is indicative of an offset from the start of a record and a type, which may be pointer or value. The instruction queue 1712 may include zero or more pointer memory location tuples and a single value memory location tuple. The search controller 1702 is further configured cause, by the compute engine 1620, the DSA 1630 to execute the instruction queue 1712.

The initialization logic 1704 is configured to initialize a search record pointer at the memory region start pointer and to initialize a memory location pointer with the search record pointer in response to initializing the search record pointer. The search record pointer may be initialized in response to the DSA 1630 executing the instruction queue 1712. The DSA 1630 may read the memory region start pointer and other parameters from the instruction queue 1712.

The pointer search engine 1706 is configured to increment the memory location pointer by a predetermined offset, read a pointer value from the memory at the memory location pointer in response to incrementing the memory location pointer, and set the memory location pointer to that pointer value. The value search engine 1708 is configured to increment the memory location pointer by a predetermined offset, read a value from the memory at the memory location pointer in response to incrementing of memory location pointer, and determine whether the value matches the predetermined search value.

The search result logic 1710 is configured to increment the search record pointer by the record length if the value does not match the predetermined search value. The search result logic 1710 is further configured to return the memory location pointer to the compute engine 1620 in response to determining that the value matches a predetermined search value.

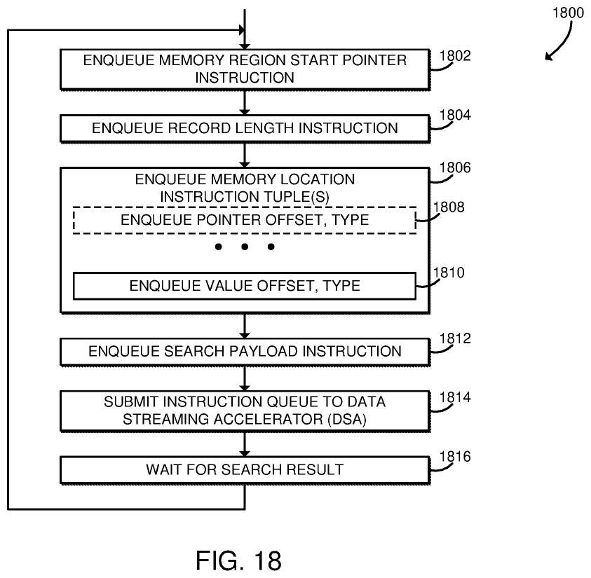

Referring now to FIG. 18, in use, the computing device 1602 may execute a method 1800 for programming an accelerated memory lookup. It should be appreciated that, in some embodiments, the operations of the method 1800 may be performed by one or more components of the environment 1700 of the computing device 1602 as shown in FIG. 17, such as the compute engine 1620. The method 1800 begins in block 1802, in which the compute engine 1620 enqueues a memory region start pointer instruction in the instruction queue 1712. The instruction may be embodied as a descriptor or other data item describing the memory region start pointer. The memory region start pointer may be embodied as any virtual memory address, physical memory address, page number, logical block address, bus address, or other identifier of a location addressable by the DSA 1630. As described further below, the memory region start pointer identifies the beginning address (e.g., lowest address) of a memory region to be searched by the DSA 1630. The memory region may be located in any addressable memory or storage region of the computing device 1602, including in the memory 1624, in a persistent memory device, or in a data storage device. In some embodiments, the memory region start pointer may identify an I/O location, such as a PCI Express (PCIe) address. As described above, the instruction queue 1712 may be stored in the memory 1624 or other memory of the computing device 1602.

In block 1804, the compute engine 1620 enqueues a record length instruction into the instruction queue 1712 that is indicative of a record length of the memory region to be searched. As described further below, the memory region to be searched includes multiple records that each have a predetermined size, which may be measured in bytes, pages, or any other appropriate measurement unit. Only the record length may be provided to the DSA 1630; the data structure of each record (e.g., whether each record is an array or vector, a “C” structure, a database row, or other structured data item) may not be known to the compute engine 1620 and/or the DSA 1630.

In block 1806, the compute engine 1620 enqueues one or more memory location instruction tuples into the instruction queue 1712. Each memory location tuple includes an offset and a type. The offset identifies the position of the memory location relative to another memory location, which may be the start of the record or another chained memory location. As with the record length, the offset may be measured in bytes, pages, or any other appropriate measurement unit. The type may be pointer type or value type. The memory location tuples enqueued in the instruction queue 1712 described the layout of the memory region to be searched. In some embodiments, in block 1808 the compute engine 1620 may enqueue a pointer-type memory location tuple, including an associated offset and the pointer type. As described further below, the DSA 1630 reads a pointer value at the offset and follows that pointer value (i.e., dereferences the pointer) to reach a chained memory location. As shown in FIG. 18, zero or more pointer-type memory location tuples may be enqueued in the instruction queue 1712. The relative order of the pointer-type memory location tuples is also recorded in the instruction queue 1712. The offset for each pointer-type memory location may be relative to the beginning of the current record (for the first pointer) or to the previously followed pointer. In block 1810 the compute engine 1620 enqueues a value-type memory location tuple, including an associated offset and the value type. As described further below, the DSA 1630 reads a value at the offset and performs a search comparison on that value. A single value-type memory location may be enqueued in the instruction queue 1712. The offset for the value-type memory location may be relative to the beginning of the current record (for a flat lookup with no pointer dereferencing) or to the last-followed pointer.

In block 1812, the compute engine 1620 enqueues the search payload instruction into the instruction queue 1712. The search payload instruction is indicative of the search payload, which is the data item that the DSA 1630 is to search for. The search payload is flexible and may be embodied as any specified value or pattern. The search payload may have arbitrary size, and in some embodiments the size may also be specified by the compute engine 1620.

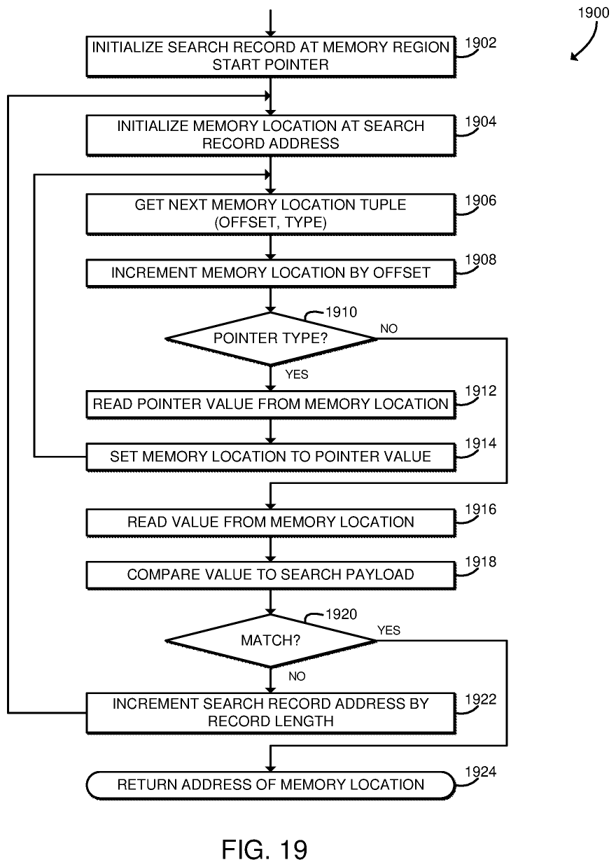

In block 1814, the compute engine 1620 submits the instruction queue 1712 to the DSA 1630 for execution. The compute engine 1620 may use any technique to submit the instruction queue 1712. For example, in some embodiments the compute engine 1620 may execute a specialized processor instruction to submit the instruction queue 1712. As described below in connection with FIG. 19, after submission of the instruction queue 1712, the compute engine 1620 searches the specified memory region for the specified search payload.

In block 1816, the compute engine 1620 waits for a search result from the DSA 1630. The compute engine 1620 may, for example, wait for an interrupt, I/O completion, or other signal from the DSA 1630. While waiting for the DSA 1630 to complete the search, the compute engine 1620 may perform other tasks, enter a sleep state, or otherwise operate independent of the DSA 1630. Upon completion of the search, the compute engine 1620 may read search results from the DSA 1630, for example by reading one or more registers, I/O completions, or other data provided by the DSA 1630. The search results may include the address of a memory location that includes data matching the search payload. After receiving the search result, the method 1800 loops back to block 1802 to program additional searches.

Referring now to FIG. 19, in use, the computing device 1602 may execute a method 1900 for performing an accelerated memory lookup. It should be appreciated that, in some embodiments, the operations of the method 1900 may be performed by one or more components of the environment 1700 of the computing device 1602 as shown in FIG. 17, such as the DSA 1630. The method 1900 begins in block 1902, in which the DSA 1630 initializes a search record at the memory region start pointer. The memory region start pointer is specified by the compute engine 1620 as described above in connection with FIG. 18. The search record is initialized as pointing to the record at the start of the memory region to be searched (e.g., the record at offset zero). As described above, the memory region to be searched may be located in any addressable memory or storage region of the computing device 1602, including in the memory 1624, in a persistent memory device, in a data storage device, or an I/O device.

In block 1904, the DSA 1630 initializes a memory location at the address of the current search record. The memory location is thus initialized at the start of the current search record (e.g., the memory location at offset zero).

In block 1906, the DSA 1630 gets the next memory location tuple. As described above in connection with FIG. 18, the compute engine 1620 specifies one or more memory location tuples that describe the layout of the memory region to be searched. Each memory location tuple includes an offset and a type. The offset identifies the position of the memory location relative to another memory location, which may be the start of the record or another chained memory location. The type may be pointer type or value type. The DSA 1630 processes the memory location tuples in an order specified by the compute engine 1620, starting with zero or more pointer-type tuples and finishing with a single value-type tuple.

In block 1908, the DSA 1630 increments the memory location by the offset of the current memory location tuple. The offset may be measured in bytes, pages, or any other appropriate measurement unit. In block 1910, the DSA 1630 determines whether the current memory location tuple is a pointer type. If not (i.e., if the tuple is value-type), the method 1900 branches to block 1916, described below. If the memory location tuple is pointer-type, the method 1900 advances to block 1912.

In block 1912, the DSA 1630 reads a pointer value from the memory location. As described above, the pointer value may be read from any addressable memory or storage region of the computing device 1602, including from the memory 1624, from a persistent memory device, from a data storage device, or from an I/O location such as a PCIe address. In block 1914, the DSA 1630 sets the memory location to the pointer value read from the previous memory location. Thus, the DSA 1630 may follow a pointer to a different data structure, which may be stored in the same memory device or in a different memory device. After setting the memory location, the method 1900 loops back to block 1906 to process additional memory location tuples.

Referring back to block 1910, if the current tuple is value-type, the method 1900 branches to block 1916, in which the DSA 1630 reads a value from the memory location. As described above, the pointer value may be read from any addressable memory or storage region of the computing device 1602, including from the memory 1624, from a persistent memory device, from a data storage device, or from an I/O location such as a PCIe address. The value read may have the same size as the search payload specified by the compute engine 1620.

In block 1918, the DSA 1630 compares the value read from the memory location to the search payload specified by the compute engine 1620. The DSA 1630 may, for example, perform a bitwise, bytewise, or other comparison to determine whether the value exactly matches the search payload. In some embodiments, the DSA 1630 may read the value from the memory location and compare the value to the search payload in a single operation (e.g., a memcmp operation).

In block 1920 the DSA 1630 determines whether the value read from the memory matches the search payload based on the comparison. If the value and the payload match, the method 1900 branches to block 1924, described below. If the value and the payload do not match, the method 1900 advances to block 1922.

In block 1922 the DSA 1630 increments the search record address by the record length specified by the compute engine 1620. Incrementing the search record address thus advances the search to the next record in the memory region to be searched. After incrementing the search record, the method 1900 loops back to block 1904 to initialize the memory location at the beginning of the next search record and continue searching.

Referring back to block 1920, if the value read from the memory location matches the search payload, the method 1900 branches to block 1924, in which the DSA 1630 returns the address of the memory location to the compute engine 1620. The DSA 1630 may use any appropriate technique to return the memory location. The DSA 1630 may, for example, assert an interrupt, generate an I/O completion, or raise another signal to the compute engine 1620. After returning the address of the memory location, the method 1900 is completed. The DSA 1630 may perform additional memory lookups at the instruction of the compute engine 1620.

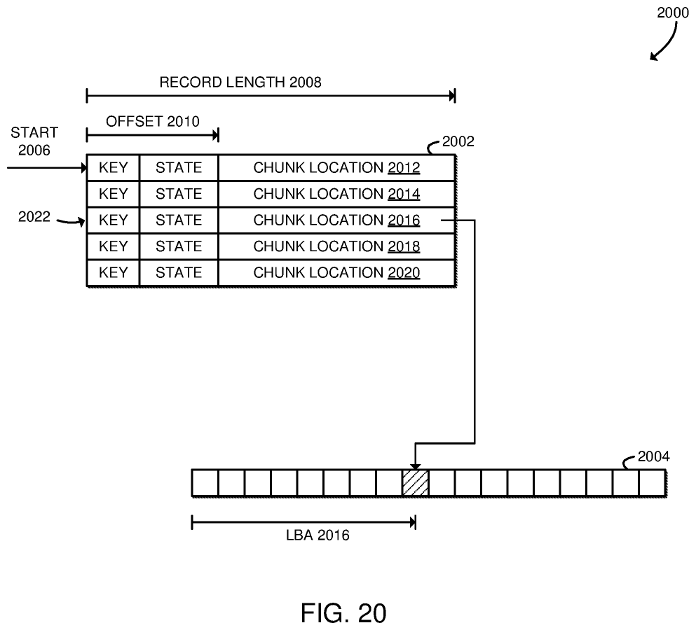

Referring now to FIG. 20, diagram 2000 illustrates an example accelerated memory lookup that may be performed by the system 1600. In the illustrative example, an object metadata structure 2002 includes metadata describing multiple data objects that are stored in an object store 2004. Illustratively, the object metadata structure 2002 is located in volatile memory (such as system main memory and/or disk controller memory) and the object store 2004 is located in a persistent memory device. Each object in the object store 2004 is identified by a logical byte address (LBA), which is an internal identifier used by the persistent memory device. Each record of the object metadata structure 2002 includes a chunk location field that identifies an LBA of the associated object. As shown, the structure 2002 includes records for chunk locations 2012 to 2020.

In illustrative example, it is supposed that an object located in the object store 2004 at LBA 2016 is corrupted (e.g., due to power failure, hardware failure, software bug, etc.). To respond, the computing device 1602 should identify an entry in the object metadata structure 2002 that corresponds to the corrupt object.

To perform the search, the compute engine 1620 programs the DSA 1630 with a start pointer 2006 and a record length 2008 associated with the structure 2002. For this example, the search involves a flat lookup and thus a single value-type tuple is supplied. The compute engine 1620 thus programs the DSA 1630 with an offset 2010 and supplies the LBA 2016 as the search payload. The compute engine 1620 instructs the DSA 1630 to begin searching.

The DSA 1630 starts with a record in the structure 2002 located at the start pointer 2006. The DSA 1630 reads the value 2012 at the offset 2010 relative to the start of the record, and compares that value 2012 to the LBA 2016. Because those values do not match, the DSA increments the search record by the record length 2008 to move to the next record (which includes the value 2014). The DSA 1630 continues until reaching record 2022, which includes at offset 2010 the value 2016 that matches the LBA 2016 that was supplied as the search payload. The DSA 1630 returns the address of the value 2016 within the structure 2002 to the compute engine 1620.

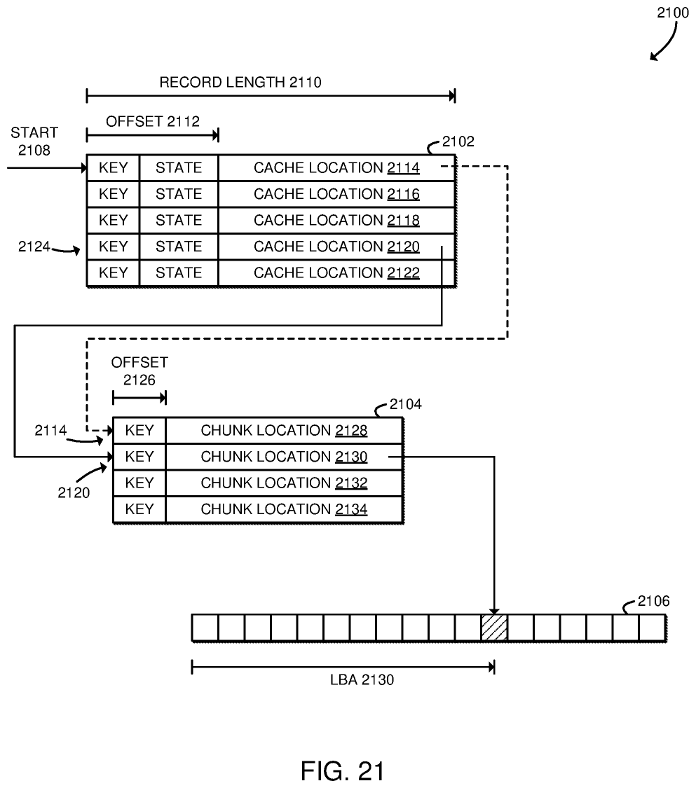

Referring now to FIG. 21, diagram 2100 illustrates an example accelerated chained memory lookup that may be performed by the system 1600. In the illustrative example, an object metadata structure 2102 includes metadata describing multiple data objects that are stored in an object store 2106. The object metadata structure references a read cache 2104, and entries of the read cache 2104 reference the objects in the object store 2106. Similar to the example of FIG. 20, the object metadata structure 2102 and the read cache 2104 are located in volatile memory (such as system main memory and/or disk controller memory) and the object store 2106 is located in a persistent memory device. Each object in the object store 2106 is identified by an LBA. Each record of the object metadata structure 2102 includes a cache location field identifying a record in the read cache 2104, and each record of the read cache 2104 includes a chunk location field that identifies an LBA of the associated object. As shown, the structure 2102 includes records for cache locations 2114 to 2122, and the read cache 2104 includes records for chunk locations 2128 to 2134.

In illustrative example, it is supposed that an object located in the object store 2106 at LBA 2130 is corrupted (e.g., due to power failure, hardware failure, software bug, etc.). To respond, the computing device 1602 should identify an entry in the read cache 2104 that corresponds to the corrupt object.

To perform the search, the compute engine 1620 programs the DSA 1630 with a start pointer 2108 and a record length 2110 associated with the structure 2102. For this example, the search involves a chained lookup and thus a pointer-type tuple and a value-type tuple are supplied. The compute engine 1620 programs the DSA 1630 with an offset 2112 for the pointer tuple and with an offset 2126 for the value tuple. The compute engine 1620 supplies the LBA 2130 as the search payload. The compute engine 1620 instructs the DSA 1630 to begin searching.

The DSA 1630 starts with a record in the structure 2102 located at the start pointer 2108. The DSA 1630 reads a pointer value 2114 at the offset 2112 relative to the start of the record, and follows that pointer to the record in the read cache 2104 located at cache location 2114. Illustratively, the DSA 1630 reads a value 2128 at the offset 2126 relative to the followed pointer, and compares that value 2128 to the LBA 2130. Because those values do not match, the DSA increments the search record by the record length 2110 to move to the next record (which includes the cache location 2116). The DSA 1630 continues searching until reaching record 2124, which includes the cache location pointer 2120 at offset 2112. As shown, an entry in the read cache 2104 at the cache location 2120 includes the value 2130 at offset 2126 that matches the LBA 2130 that was supplied as the search payload. The DSA 1630 returns the address of the value 2130 within the read cache 2104 to the compute engine 1620. Although illustrated as including a single pointer lookup in FIG. 21, it should be understood that in some embodiments, the search may include multiple chained pointer lookups.

### EXAMPLES

Illustrative examples of the technologies disclosed herein are provided below. An embodiment of the technologies may include any one or more, and any combination of, the examples described below.

Example 1 includes a computing device for memory lookup, the computing device comprising a processor; and a hardware accelerator coupled to the processor, wherein the hardware accelerator comprises initialization logic to (i) initialize a search record pointer at a memory region start pointer, wherein the search record pointer references a memory of the computing device, and (ii) initialize a memory location pointer with the search record pointer in response to initializing the search record pointer; a value search engine to (i) increment the memory location pointer by a first predetermined offset, (ii) read a value from the memory at the memory location pointer in response to incrementing of the memory location pointer, and (iii) determine whether the value matches a predetermined search value; and search result logic to (i) increment the search record pointer by a predetermined record length in response to a determination that the value does not match the predetermined search value, and (ii) return the memory location pointer to the processor in response to a determination that the value matches a predetermined search value.

Example 2 includes the subject matter of Example 1, and wherein the hardware accelerator further comprises a pointer search engine to (i) increment the memory location pointer by a second predetermined offset, (ii) read a pointer value from the memory at the memory location pointer in response to incrementing of the memory location pointer by the second predetermined offset, and (iii) set the memory location pointer to the pointer value; wherein to increment the memory location pointer by the first predetermined offset comprises to increment the memory location pointer by the first predetermined offset in response to setting of the memory location pointer to the pointer value.

Example 3 includes the subject matter of any of Examples 1 and 2, and further including a search controller to (i) program, by the processor, an instruction queue for the hardware accelerator, wherein the instruction queue is indicative of the predetermined search value, the memory region start pointer, the predetermined offset, and the predetermined record length; and (ii) cause, by the processor, the hardware accelerator to execute the instruction queue; wherein to initialize the search record pointer comprises to initialize the search record pointer in response to causing of the hardware accelerator to execute the instruction queue.

Example 4 includes the subject matter of any of Examples 1-3, and wherein the instruction queue comprises a plurality of descriptors stored in the memory of the computing device.

Example 5 includes the subject matter of any of Examples 1-4, and wherein the instruction queue is further indicative of a plurality of memory location tuples, wherein each memory location tuple is indicative of a predetermined offset and a type.

Example 6 includes the subject matter of any of Examples 1-5, and wherein the plurality of memory location tuples comprises a first memory location tuple, wherein the first memory location tuple is indicative of the first predetermined offset and a value type.

Example 7 includes the subject matter of any of Examples 1-6, and wherein the plurality of memory location tuples further comprises a second memory location tuple, wherein the second memory location tuple is indicative of a second predetermined offset and a pointer type.

Example 8 includes the subject matter of any of Examples 1-7, and wherein the memory comprises a volatile memory device.

Example 9 includes the subject matter of any of Examples 1-8, and wherein the memory comprises a persistent memory device.

Example 10 includes the subject matter of any of Examples 1-9, and wherein the predetermined search value comprises a logical byte address of a first object stored in a persistent memory device of the computing device, wherein first object is associated with object metadata stored in the memory of the computing device.

Example 11 includes the subject matter of any of Examples 1-10, and wherein the hardware accelerator comprises a data streaming accelerator.

Example 12 includes the subject matter of any of Examples 1-11, and wherein the hardware accelerator comprises a memory controller.

Example 13 includes a method for memory lookup, the method comprising initializing, by a hardware accelerator of a computing device, a search record pointer at a memory region start pointer, wherein the search record pointer references a memory of the computing device; initializing, by the hardware accelerator, a memory location pointer with the search record pointer in response to initializing the search record pointer; incrementing, by the hardware accelerator, the memory location pointer by a first predetermined offset; reading, by the hardware accelerator, a value from the memory at the memory location pointer in response to incrementing the memory location pointer; determining, by the hardware accelerator, whether the value matches a predetermined search value; incrementing, by the hardware accelerator, the search record pointer by a predetermined record length in response to determining that the value does not match the predetermined search value; and returning, by the hardware accelerator, the memory location pointer to a processor of the computing device in response to determining that the value matches a predetermined search value.

Example 14 includes the subject matter of Example 13, and further including incrementing, by the hardware accelerator, the memory location pointer by a second predetermined offset; reading, by the hardware accelerator, a pointer value from the memory at the memory location pointer in response to incrementing the memory location pointer by the second predetermined offset; and setting, by the hardware accelerator, the memory location pointer to the pointer value; wherein incrementing the memory location pointer by the first predetermined offset comprises incrementing the memory location pointer by the first predetermined offset in response to setting the memory location pointer to the pointer value.

Example 15 includes the subject matter of any of Examples 13 and 14, and further including programming, by the processor, an instruction queue for the hardware accelerator, wherein the instruction queue is indicative of the predetermined search value, the memory region start pointer, the predetermined offset, and the predetermined record length; and causing, by the processor, the hardware accelerator to execute the instruction queue; wherein initializing the search record pointer comprises initializing the search record pointer in response to causing the hardware accelerator to execute the instruction queue.

Example 16 includes the subject matter of any of Examples 13-15, and wherein the instruction queue comprises a plurality of descriptors stored in the memory of the computing device.

Example 17 includes the subject matter of any of Examples 13-16, and wherein the instruction queue is further indicative of a plurality of memory location tuples, wherein each memory location tuple is indicative of a predetermined offset and a type.

Example 18 includes the subject matter of any of Examples 13-17, and wherein the plurality of memory location tuples comprises a first memory location tuple, wherein the first memory location tuple is indicative of the first predetermined offset and a value type.

Example 19 includes the subject matter of any of Examples 13-18, and wherein the plurality of memory location tuples further comprises a second memory location tuple, wherein the second memory location tuple is indicative of a second predetermined offset and a pointer type.

Example 20 includes the subject matter of any of Examples 13-19, and wherein the memory comprises a volatile memory device.

Example 21 includes the subject matter of any of Examples 13-20, and wherein the memory comprises a persistent memory device.

Example 22 includes the subject matter of any of Examples 13-21, and wherein the predetermined search value comprises a logical byte address of a first object stored in a persistent memory device of the computing device, wherein first object is associated with object metadata stored in the memory of the computing device.

Example 23 includes the subject matter of any of Examples 13-22, and wherein the hardware accelerator comprises a data streaming accelerator.

Example 24 includes the subject matter of any of Examples 13-23, and wherein the hardware accelerator comprises a memory controller.

Example 25 includes a computing device comprising a processor; and a memory having stored therein a plurality of instructions that when executed by the processor cause the computing device to perform the method of any of Examples 13-24.

Example 26 includes one or more non-transitory, computer readable storage media comprising a plurality of instructions stored thereon that in response to being executed result in a computing device performing the method of any of Examples 13-24.

Example 27 includes a computing device comprising means for performing the method of any of Examples 13-24.

1. A computing device for memory lookup, the computing device comprising:
a processor; and
a hardware accelerator coupled to the processor, wherein the hardware accelerator comprises:
initialization logic to (i) initialize a search record pointer at a memory region start pointer, wherein the search record pointer references a memory of the computing device, and (ii) initialize a memory location pointer with the search record pointer in response to initializing the search record pointer;
a value search engine to (i) increment the memory location pointer by a first predetermined offset, (ii) read a value from the memory at the memory location pointer in response to incrementing of the memory location pointer, and (iii) determine whether the value matches a predetermined search value; and
search result logic to (i) increment the search record pointer by a predetermined record length in response to a determination that the value does not match the predetermined search value, and (ii) return the memory location pointer to the processor in response to a determination that the value matches a predetermined search value.

2. The computing device of claim 1, wherein:
the hardware accelerator further comprises a pointer search engine to (i) increment the memory location pointer by a second predetermined offset, (ii) read a pointer value from the memory at the memory location pointer in response to incrementing of the memory location pointer by the second predetermined offset, and (iii) set the memory location pointer to the pointer value;
wherein to increment the memory location pointer by the first predetermined offset comprises to increment the memory location pointer by the first predetermined offset in response to setting of the memory location pointer to the pointer value.

3. The computing device of claim 1, further comprising:
a search controller to (i) program, by the processor, an instruction queue for the hardware accelerator, wherein the instruction queue is indicative of the predetermined search value, the memory region start pointer, the predetermined offset, and the predetermined record length; and (ii) cause, by the processor, the hardware accelerator to execute the instruction queue;
wherein to initialize the search record pointer comprises to initialize the search record pointer in response to causing of the hardware accelerator to execute the instruction queue.

4. The computing device of claim 3, wherein the instruction queue comprises a plurality of descriptors stored in the memory of the computing device.

5. The computing device of claim 3, wherein the instruction queue is further indicative of a plurality of memory location tuples, wherein each memory location tuple is indicative of a predetermined offset and a type.

6. The computing device of claim 5, wherein the plurality of memory location tuples comprises a first memory location tuple, wherein the first memory location tuple is indicative of the first predetermined offset and a value type.

7. The computing device of claim 6, wherein the plurality of memory location tuples further comprises a second memory location tuple, wherein the second memory location tuple is indicative of a second predetermined offset and a pointer type.

8. The computing device of claim 1, wherein the memory comprises a persistent memory device.

9. The computing device of claim 1, wherein the predetermined search value comprises a logical byte address of a first object stored in a persistent memory device of the computing device, wherein first object is associated with object metadata stored in the memory of the computing device.

10. The computing device of claim 1, wherein the hardware accelerator comprises a data streaming accelerator.

11. The computing device of claim 1, wherein the hardware accelerator comprises a memory controller.

12. A method for memory lookup, the method comprising:
initializing, by a hardware accelerator of a computing device, a search record pointer at a memory region start pointer, wherein the search record pointer references a memory of the computing device;
initializing, by the hardware accelerator, a memory location pointer with the search record pointer in response to initializing the search record pointer;
incrementing, by the hardware accelerator, the memory location pointer by a first predetermined offset;
reading, by the hardware accelerator, a value from the memory at the memory location pointer in response to incrementing the memory location pointer;
determining, by the hardware accelerator, whether the value matches a predetermined search value;
incrementing, by the hardware accelerator, the search record pointer by a predetermined record length in response to determining that the value does not match the predetermined search value; and
returning, by the hardware accelerator, the memory location pointer to a processor of the computing device in response to determining that the value matches a predetermined search value.

13. The method of claim 12, further comprising:
incrementing, by the hardware accelerator, the memory location pointer by a second predetermined offset;
reading, by the hardware accelerator, a pointer value from the memory at the memory location pointer in response to incrementing the memory location pointer by the second predetermined offset; and
setting, by the hardware accelerator, the memory location pointer to the pointer value;
wherein incrementing the memory location pointer by the first predetermined offset comprises incrementing the memory location pointer by the first predetermined offset in response to setting the memory location pointer to the pointer value.

14. The method of claim 12, further comprising:
programming, by the processor, an instruction queue for the hardware accelerator, wherein the instruction queue is indicative of the predetermined search value, the memory region start pointer, the predetermined offset, and the predetermined record length; and
causing, by the processor, the hardware accelerator to execute the instruction queue;
wherein initializing the search record pointer comprises initializing the search record pointer in response to causing the hardware accelerator to execute the instruction queue.

15. The method of claim 14, wherein the instruction queue is further indicative of a plurality of memory location tuples, wherein each memory location tuple is indicative of a predetermined offset and a type.

16. The method of claim 15, wherein the plurality of memory location tuples comprises a first memory location tuple, wherein the first memory location tuple is indicative of the first predetermined offset and a value type.

17. The method of claim 16, wherein the plurality of memory location tuples further comprises a second memory location tuple, wherein the second memory location tuple is indicative of a second predetermined offset and a pointer type.

18. The method of claim 12, wherein the memory comprises a persistent memory device.

19. One or more computer-readable storage media comprising a plurality of instructions stored thereon that, in response to being executed, cause a computing device to:
initialize, by a hardware accelerator of the computing device, a search record pointer at a memory region start pointer, wherein the search record pointer references a memory of the computing device;
initialize, by the hardware accelerator, a memory location pointer with the search record pointer in response to initializing the search record pointer;
increment, by the hardware accelerator, the memory location pointer by a first predetermined offset;
read, by the hardware accelerator, a value from the memory at the memory location pointer in response to incrementing the memory location pointer;
determine, by the hardware accelerator, whether the value matches a predetermined search value;
increment, by the hardware accelerator, the search record pointer by a predetermined record length in response to determining that the value does not match the predetermined search value; and
return, by the hardware accelerator, the memory location pointer to a processor of the computing device in response to determining that the value matches a predetermined search value.

20. The one or more computer-readable storage media of claim 19, further comprising a plurality of instructions stored thereon that, in response to being executed, cause the computing device to:
increment, by the hardware accelerator, the memory location pointer by a second predetermined offset;
read, by the hardware accelerator, a pointer value from the memory at the memory location pointer in response to incrementing the memory location pointer by the second predetermined offset; and
set, by the hardware accelerator, the memory location pointer to the pointer value;
wherein to increment the memory location pointer by the first predetermined offset comprises to increment the memory location pointer by the first predetermined offset in response to setting the memory location pointer to the pointer value.

21. The one or more computer-readable storage media of claim 19, further comprising a plurality of instructions stored thereon that, in response to being executed, cause the computing device to:
program, by the processor, an instruction queue for the hardware accelerator, wherein the instruction queue is indicative of the predetermined search value, the memory region start pointer, the predetermined offset, and the predetermined record length; and
cause, by the processor, the hardware accelerator to execute the instruction queue;
wherein to initialize the search record pointer comprises to initialize the search record pointer in response to causing the hardware accelerator to execute the instruction queue.

22. The one or more computer-readable storage media of claim 21, wherein the instruction queue is further indicative of a plurality of memory location tuples, wherein each memory location tuple is indicative of a predetermined offset and a type.

23. The one or more computer-readable storage media of claim 22, wherein the plurality of memory location tuples comprises a first memory location tuple, wherein the first memory location tuple is indicative of the first predetermined offset and a value type.

24. The one or more computer-readable storage media of claim 23, wherein the plurality of memory location tuples further comprises a second memory location tuple, wherein the second memory location tuple is indicative of a second predetermined offset and a pointer type.

25. The one or more computer-readable storage media of claim 19, wherein the memory comprises a persistent memory device.
